(19) United States
(12) Patent Application Publication
(10) Pub. No.: US 2024/0214949 A1
(43) Pub. Date: Jun. 27, 2024

(54) COMPRESSED RADIO FREQUENCY EXPOSURE MAP

(71) Applicant: QUALCOMM Incorporated, San Diego, CA (US)

(72) Inventors: Nandhini SRINIVASAN, San Diego, CA (US); Jagadish NADAKUDUTI, Bermuda Dunes, CA (US); Lin LU, San Diego, CA (US); Paul GUCKIAN, La Jolla, CA (US)

(21) Appl. No.: 18/544,768

(22) Filed: Dec. 19, 2023

Related U.S. Application Data
(60) Provisional application No. 63/476,615, filed on Dec. 21, 2022.

(51) Int. Cl. H04W 52/36; H04W 52/24

(52) U.S. Cl. CPC H04W 52/365; H04W 52/248

(57) ABSTRACT

Techniques and apparatus for generating a compressed radio frequency (RF) exposure map and using such a compressed RF exposure map for determining a transmit power to meet RF exposure compliance limits are described. An example method generally includes obtaining a first RF exposure map associated with at least one antenna of a wireless device and converting the first RF exposure map to a second RF exposure map. The second RF exposure map is compressed compared to the first RF exposure map. Another example method includes accessing an RF exposure map associated with at least one antenna of the wireless device. The RF exposure map includes a representation of a maximum RF exposure for a region of the RF exposure map. The method also includes transmitting, from the antenna(s), a signal at a transmit power determined based on the RF exposure map in compliance with an RF exposure limit.

### CROSS-REFERENCE TO RELATED APPLICATION

This application claims the benefit of U.S. Provisional Patent Application Ser. No. 63/476,615, filed Dec. 21, 2022, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless devices (such as cellular telephones) are generally mandated to meet radio frequency (RF) exposure limits set by certain governments and international standards and regulations. To ensure compliance with the standards, such devices typically undergo an extensive certification process prior to being shipped to market. To ensure that a wireless device complies with an RF exposure limit, techniques have been developed to enable the wireless device to assess RF exposure from the wireless device and adjust the transmission power of the wireless device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance.

Certain aspects of the subject matter described in this disclosure can be implemented in a method for generating a radio frequency (RF) exposure map. The method generally includes obtaining a first RF exposure map associated with at least one antenna of a wireless device. The method also includes converting the first RF exposure map to a second RF exposure map. The second RF exposure map is compressed compared to the first RF exposure map.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to obtain a first RF exposure map associated with at least one antenna of a wireless device, and convert the first RF exposure map to a second RF exposure map. The second RF exposure map is compressed compared to the first RF exposure map.

Certain aspects of the subject matter described in this disclosure can be implemented in an apparatus for wireless communication. The apparatus generally includes means for obtaining a first RF exposure map associated with at least one antenna of a wireless device. The apparatus also includes means for converting the first RF exposure map to a second RF exposure map. The second RF exposure map is compressed compared to the first RF exposure map.

Certain aspects of the subject matter described in this disclosure can be implemented in a computer-readable medium. The computer-readable medium has instructions stored thereon, that when executed by an apparatus, cause the apparatus to perform an operation. The operation generally includes obtaining a first RF exposure map associated with at least one antenna of a wireless device. The operation also includes converting the first RF exposure map to a second RF exposure map. The second RF exposure map is compressed compared to the first RF exposure map.

Certain aspects of the subject matter described in this disclosure can be implemented in a method for wireless communication by a wireless device. The method generally includes accessing a radio frequency (RF) exposure map associated with at least one antenna of the wireless device. The RF exposure map includes a representation of a maximum RF exposure for a region of the RF exposure map. The method also includes transmitting, from the at least one antenna, a signal at a transmit power determined based at least in part on the RF exposure map in compliance with an RF exposure limit.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to access a radio frequency (RF) exposure map associated with at least one antenna of the apparatus. The RF exposure map includes a representation of a maximum RF exposure for a region of the RF exposure map. The one or more processors are also collectively configured to execute the executable instructions to cause the apparatus to transmit, from the at least one antenna, a signal at a transmit power determined based at least in part on the RF exposure map in compliance with an RF exposure limit.

Certain aspects of the subject matter described in this disclosure can be implemented in an apparatus for wireless communication. The apparatus generally includes means for accessing a radio frequency (RF) exposure map associated with at least one antenna of the apparatus. The RF exposure map includes a representation of a maximum RF exposure for a region of the RF exposure map. The apparatus also includes means for transmitting, from the at least one antenna, a signal at a transmit power determined based at least in part on the RF exposure map in compliance with an RF exposure limit.

Certain aspects of the subject matter described in this disclosure can be implemented in a computer-readable medium. The computer-readable medium has instructions stored thereon, that when executed by an apparatus, cause the apparatus to perform an operation. The operation generally includes accessing a radio frequency (RF) exposure map associated with at least one antenna of the apparatus. The RF exposure map includes a representation of a maximum RF exposure for a region of the RF exposure map. The operation also includes transmitting, from the at least one antenna, a signal at a transmit power determined based at least in part on the RF exposure map in compliance with an RF exposure limit.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network.

FIG. 2 is a block diagram conceptually illustrating a design of an example base station (BS) and user equipment (UE).

FIG. 3 is a block diagram of an example radio frequency (RF) transceiver.

FIGS. 4A, 4B, and 4C are graphs illustrating examples of transmit powers over time in compliance with a time-averaged RF exposure limit.

FIG. 5 is a diagram illustrating an example system for measuring RF exposure values or distributions.

FIG. 6 is a flow diagram illustrating example operations for generating an RF exposure map, in accordance with certain aspects of the present disclosure.

FIG. 7 is a diagram illustrating a progression of generating the RF exposure map from one or more RF distributions, in accordance with certain aspects of the present disclosure.

FIG. 8 is a diagram illustrating eight normalized composite maps per antenna being added together to obtain a total exposure map, in accordance with certain aspects of the present disclosure.

FIG. 9 illustrates an example total exposure map and an updated version of the total exposure map with compliant locations set to a specific value, in accordance with certain aspects of the present disclosure.

FIG. 10 illustrates examples of identifying non-compliant regions until all of the non-compliant areas are covered with identified regions, in accordance with certain aspects of the present disclosure.

FIG. 11 illustrates an example of a subset of non-compliant regions selected for a compressed RF exposure map, in accordance with certain aspects of the present disclosure.

FIG. 12 illustrates examples of composite maps and a corresponding subset of non-compliant regions, in accordance with certain aspects of the present disclosure.

FIG. 13 illustrates an example table of maximum RF exposure values associated with a particular map per region, in accordance with certain aspects of the present disclosure.

FIG. 14 is a flow diagram illustrating example operations for generating an RF exposure map with further details, in accordance with certain aspects of the present disclosure.

FIG. 15 is an example plot illustrating the average backoff difference in decibels for different ON/OFF combinations of antennas across different test cases, in accordance with certain aspects of the present disclosure.

FIG. 16 is a diagram illustrating an RF exposure map being segmented into multiple regions, in accordance with certain aspects of the present disclosure.

FIG. 17 is a flow diagram illustrating example operations for generating an RF exposure map, in accordance with certain aspects of the present disclosure.

FIG. 18 is a flow diagram illustrating example operations for wireless communication by a wireless device, in accordance with certain aspects of the present disclosure.

FIG. 19 illustrates a communications device (e.g., a UE) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for generating and/or using a compressed radio frequency (RF) exposure map associated with a wireless device.

In certain cases, a wireless communications device may evaluate RF exposure compliance using a two-dimensional RF exposure distribution (e.g., a specific absorption rate (SAR) distribution and/or power density (PD) distribution). The wireless device may perform the SAR and PD assessment over a given time window to determine a maximum allowable transmit power using the RF exposure distribution. The RF exposure distribution may represent the maximum RF exposure exhibited by one or more antennas of the wireless device. In some cases, the RF exposure distribution may be a look-up table of maximum RF exposures exhibited by antennas transmitting at various frequency bands. Each of the maximum RF exposures may correspond to the peak RF exposure across all of the surfaces of the wireless device, such that there is no distinction with respect to where the RF exposure is being emitted from the wireless device. While aspects described herein refer to two-dimensional (2D) distributions, it will be understood that the described operations and configurations may also be applied to three-dimensional maps or distributions.

Aspects of the present disclosure provide apparatus and methods for generating and/or using a compressed RF exposure map, where the compressed RF exposure map may be representative of maximum RF exposures exhibited in particular regions of the wireless device for certain radio combinations. The RF exposure map may be reduced to maximum RF exposures in certain regions across the wireless device, such that the wireless device evaluates RF exposure compliance across the regions identified for the RF exposure map. In certain aspects, the compressed RF exposure map may be representative of the RF exposure in terms of SAR and/or PD.

The apparatus and methods for generating and using the compressed RF exposure map described herein may facilitate improved wireless communication performance (e.g., improved signal quality at the receiver, lower latencies, higher throughput, etc.). The apparatus and methods for generating and using the compressed RF exposure map described herein may also enable improved processing performance, for example, due to the reduced memory size used by the compressed RF exposure map and/or the reduced number of computations used to perform the RF exposure evaluation to satisfy time-averaged RF exposure compliance during simultaneous transmission scenarios.

As used herein, a radio may refer to one or more active bands, transceivers, and/or radio access technologies (RATs) (e.g., 2G or 3G such as code division multiple access (CDMA), 4G such as Long Term Evolution (LTE), 5G New Radio (NR), IEEE 802.11, Bluetooth, non-terrestrial network (NTN) communications, etc.) used for wireless communications. For example, for uplink carrier aggregation in LTE and/or NR, each of the active component carriers used for wireless communications may be treated as a separate radio. Similarly, multi-band transmissions for IEEE 802.11 communications may be treated as separate radios for each band (e.g., 2.4 gigahertz (GHz), 5 GHZ, or 6 GHz).

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems and/or to wireless technologies such as 802.11, 802.15, NTN communications, etc.

NR access may support various wireless communication services, such as enhanced mobile broadband (cMBB) targeting wide bandwidth (e.g., 80 megahertz (MHz) or beyond), millimeter wave (mmWave) targeting high carrier frequency (e.g., 24 GHz to 53 GHz or beyond), massive machine type communications (MTC) (mMTC) targeting non-backward compatible MTC techniques, and/or mission critical targeting ultra-reliable low-latency communications (URLLC). These services may include latency and reliability specifications. These services may also have different transmission time intervals (TTIs) to meet respective quality of service (QOS) specifications. In addition, these services may co-exist in the same subframe. NR supports beamforming, and beam direction may be dynamically configured. Multiple-input, multiple-output (MIMO) transmissions with precoding may also be supported, as may multi-layer transmissions. Aggregation of multiple cells may be supported.

### Example Wireless Communication Network and Devices

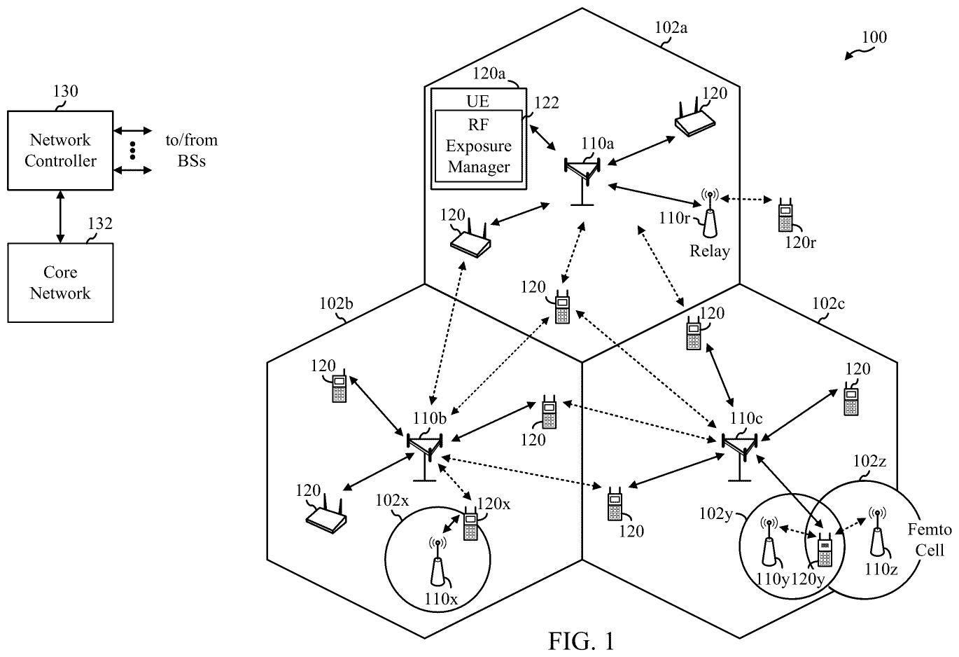

FIG. 1 illustrates an example wireless communication network 100 in which aspects of the present disclosure may be performed. For example, the wireless communication network 100 may be an NR system (e.g., a 5G NR network), an Evolved Universal Terrestrial Radio Access (E-UTRA) system (e.g., a 4G network), a Universal Mobile Telecommunications System (UMTS) (e.g., a 2G/3G network), or a code division multiple access (CDMA) system (e.g., a 2G/3G network), or may be configured for communications according to an IEEE standard such as one or more of the 802.11 standards, etc. As shown in FIG. 1, the UE 120a includes a RF exposure manager 122 that ensures RF exposure compliance using a compressed RF exposure map, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In some aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

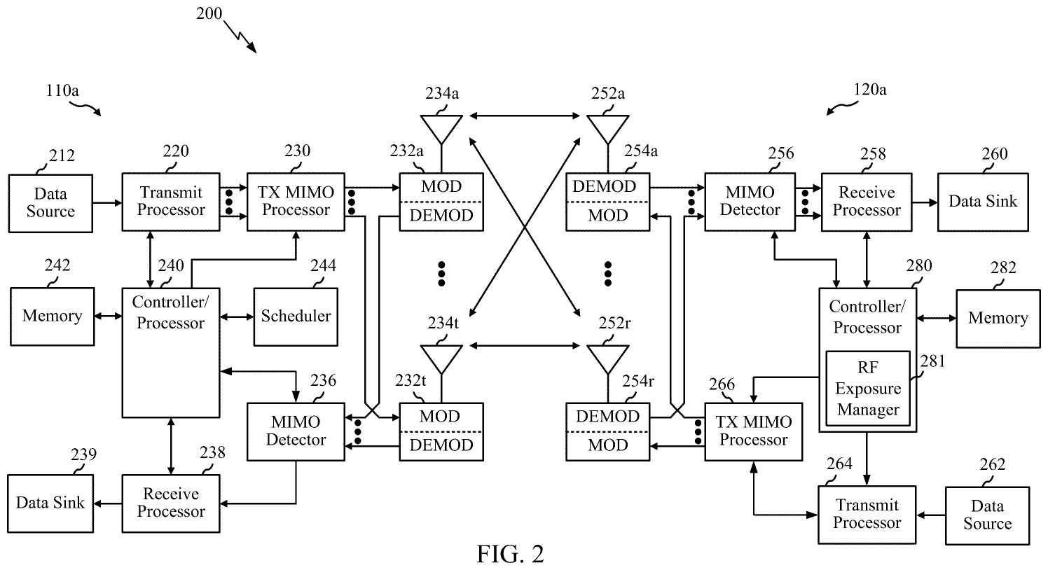

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has an RF exposure manager 281 that is representative of the RF exposure manager 122, according to aspects described herein. Although shown at the controller/processor, other components of the UE 120a and BS 110a may be used to perform the operations described herein.

NR may utilize OFDM with a cyclic prefix (CP) on the uplink and downlink. NR may support half-duplex operation using time division duplexing (TDD). OFDM and SC-FDM partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some aspects, the BS 110a illustrated in FIG. 2 and described above is an example of another UE 120.

### Example RF Transceiver

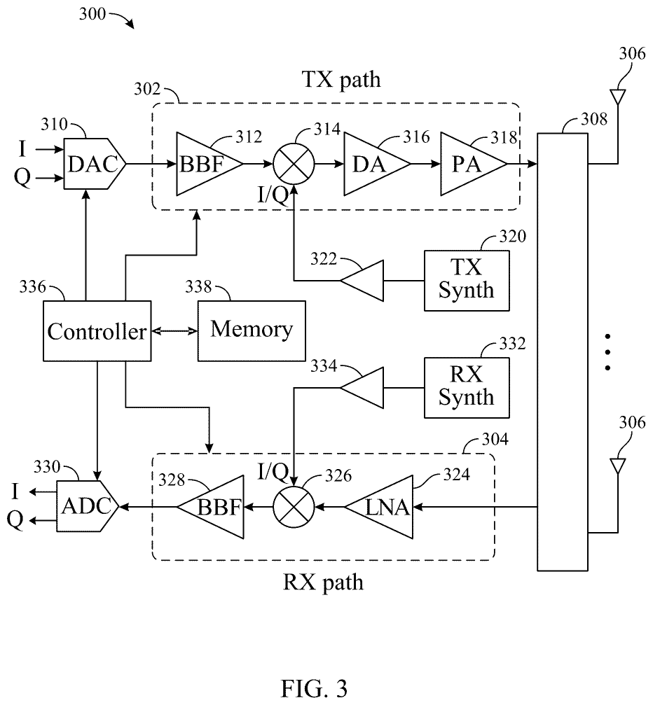

FIG. 3 is a block diagram of an example RF transceiver circuit 300, in accordance with certain aspects of the present disclosure. The RF transceiver circuit 300 includes at least one transmit (TX) path 302 (also known as a transmit chain) for transmitting signals via one or more antennas 306 and at least one receive (RX) path 304 (also known as a receive chain) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, and the DA 316 may be included in one or more radio frequency integrated circuits (RFICs). The PA 318 may be external to the RFIC(s) for some implementations.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 314 are typically RF signals, which may be amplified by the DA 316 and/or by the PA 318 before transmission by the antenna 306. While one mixer 314 is illustrated, several mixers may be used to upconvert the filtered baseband signals to one or more intermediate frequencies and to thereafter upconvert the intermediate frequency signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I or Q signals for digital signal processing.

Certain transceivers may employ frequency synthesizers with a voltage-controlled oscillator (VCO) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326.

A controller 336 may direct the operation of the RF transceiver circuit 300, such as transmitting signals via the TX path 302 and/or receiving signals via the RX path 304. The controller 336 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 338 may store data and program codes for operating the RF transceiver circuit 300. The controller 336 and/or memory 338 may include control logic. In certain cases, the controller 336 may determine a transmit power applied to the TX path 302 (e.g., certain levels of gain applied to the BBF 312, the DA 316, and/or PA 318) that complies with an RF exposure limit set by country-specific regulations and/or international standards as further described herein.

### Example RF Exposure Compliance

RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless devices using transmission frequencies above 6 GHz. The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change.

SAR may be used to assess RF exposure for transmission frequencies less than 6 GHz, which cover wireless communication technologies such as 2G/3G (e.g., CDMA), 4G (e.g., LTE), 5G (e.g., NR in 6 GHz bands), IEEE 802.11ac, NTN, etc. PD may be used to assess RF exposure for transmission frequencies higher than 6 GHZ, which cover wireless communication technologies such as IEEE 802.11ad, 802.11ay, 5G in mmWave bands, etc. Thus, different metrics may be used to assess RF exposure for different wireless communication technologies.

A wireless device (e.g., UE 120) may simultaneously transmit signals using multiple wireless communication technologies. For example, the wireless device may simultaneously transmit signals using a first wireless communication technology operating at or below 6 GHz (e.g., 3G, 4G, 5G, etc.) and a second wireless communication technology operating above 6 GHZ (e.g., mmWave 5G in 24 to 60 GHz bands, IEEE 802.11ad or 802.11ay). In certain aspects, the wireless device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHZ bands, IEEE 802.11ad, 802.11ay, etc.) in which RF exposure is measured in terms of PD. As used herein, sub-6 GHz bands may include frequency bands of 300 MHz to 6,000 MHz in some examples, and may include bands in the 6,000 MHz and/or 7,000 MHZ range in some examples.

To assess RF exposure from transmissions using the first technology (e.g., 3G, 4G, 5G in sub-6 GHz bands, IEEE 802.11ac, NTN, etc.), the wireless communication device may include multiple SAR values and/or SAR distributions for the first technology stored in memory (e.g., memory 282 of FIG. 2 or memory 338 of FIG. 3). Each of the SAR values and/or SAR distributions may correspond to a respective one of multiple transmit scenarios supported by the wireless communication device for the first technology. The transmit scenarios may correspond to various combinations of antennas (e.g., antennas 252a through 252r of FIG. 2 or antenna 306 of FIG. 3), frequency bands, channels, and/or body positions, as discussed further below. In some examples, the stored SAR value includes a single value (e.g., a peak value determined based on the description below, or a sum of peak values).

The SAR values and/or SAR distribution (also referred to as a SAR map) for each transmit scenario may be generated based on measurements (e.g., E-field measurements) performed in a test laboratory using a model of a human body. After generation, the SAR values and/or SAR distribution may be stored in the memory to enable a processor (e.g., processor 280 of FIG. 2 and/or controller 336 of FIG. 3) to assess RF exposure in real time, as discussed further below. Each SAR distribution may include a set of SAR values, where each SAR value may correspond to a different location (e.g., on the model of the human body). Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or SAR distribution for any transmission power level by multiplying each SAR value (e.g., in the SAR distribution) by the following transmission power scaler:

$$\frac{{Tx}_{c}}{{Tx}_{SAR}} \qquad ( 1 )$$

where Tx_{c} is a current transmission power level for the respective transmit scenario, and TX_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include one or more of the following: an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a device state index (DSI)) indicating the location of the wireless communication device relative to the user's body location (head, trunk, away from the body, etc.), exposure category, and/or other parameters. In cases where the wireless communication device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or SAR distributions for the subset of transmit scenarios. In this example, the SAR values and/or SAR distributions for each of the remaining transmit scenarios may be generated by combining two or more of the SAR values and/or SAR distributions for the subset of transmit scenarios, as discussed further below.

For example, SAR measurements may be performed for each one of the antennas to generate a SAR value or SAR distribution for each one of the antennas. In this example, a SAR value or SAR distribution for a transmit scenario in which two or more of the antennas are active may be generated by combining the SAR values or SAR distributions for the two or more active antennas.

In another example, SAR measurements may be performed for each one of multiple frequency bands to generate a SAR value or SAR distribution for each one of the multiple frequency bands. In this example, a SAR value or SAR distribution for a transmit scenario in which two or more frequency bands are active may be generated by combining the SAR values or SAR distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit. In some cases, the SAR limit may correspond to a regulatory or standardized limit or may correspond to a level lower than the regulatory or standardized limit to provide sufficient exposure margin to account for device uncertainties and/or other margins (for example, for other radios).

In certain aspects, the normalized SAR value or normalized SAR distribution for a transmit scenario may be generated by combining two or more normalized SAR values or normalized SAR distributions. For example, a normalized SAR value or normalized SAR distribution for a transmit scenario in which two or more antennas are active may be generated by combining the normalized SAR values or normalized SAR distributions for the two or more active antennas. For the case in which different transmission power levels are used for the active antennas, the normalized SAR value or normalized SAR distribution for each active antenna may be scaled by the respective transmission power level before combining the normalized SAR values or normalized SAR distributions for the active antennas. The normalized SAR value or normalized SAR distribution for simultaneous transmission from multiple active antennas may be given by the following:

$$S A {R}_{norm\_combined} = {\sum }_{i = 1}^{i = K} \frac{{Tx}_{i}}{{Tx}_{SARi}} \cdot \frac{S A {R}_{i}}{S A {R}_{lim}} \qquad ( 2 )$$

where SARₗᵢₘ is a SAR limit, SAR_{norm_combined} is the combined normalized SAR value or combined normalized SAR distribution for simultaneous transmission from the active antennas, i is an index for the active antennas, SARᵢ is the SAR value or SAR distribution for the i^{th} active antenna, Txᵢ is the transmission power level for the i^{th} active antenna, TX_{SARi} is the transmission power level for the SAR distribution for the i^{th} active antenna, and K is the number of the active antennas.

Equation (2) may be rewritten as follows:

$$S A {R}_{norm\_combined} = {\sum }_{i = 1}^{i = K} \frac{{Tx}_{i}}{{Tx}_{S A R i}} \cdot {SAR}_{norm\_i} \qquad ( 3 a )$$

where SAR_{norm_i} is the normalized SAR value or normalized SAR distribution for the i^{th} active antenna. In the case of simultaneous transmissions using multiple active antennas at the same transmitting frequency (e.g., multiple-input, multiple-output (MIMO)), the combined normalized SAR value or combined normalized SAR distribution may be obtained by summing the square root of the individual normalized SAR values or normalized SAR distributions and computing the square of the sum, as given by the following:

$$S A {R}_{norm\_combined \_MIMO} = {[ {\sum }_{i = 1}^{i = K} \sqrt{\frac{{Tx}_{i}}{T {x}_{S A R i}} S A {R}_{norm\_i}} ]}^{2} . \qquad ( 3 b )$$

In another example, normalized SAR values or normalized SAR distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or normalized SAR distribution for each of the active frequency bands may be scaled by the respective transmission power level before combining the normalized SAR values or normalized SAR distributions for the active frequency bands. In this example, the combined SAR value or combined SAR distribution may also be computed using Equation (3a) in which i is an index for the active frequency bands, SAR_{norm_i} is the normalized SAR value or normalized SAR distribution for the i^{th} active frequency band, Txᵢ is the transmission power level for the i^{th} active frequency band, and TX_{SARi} is the transmission power level for the normalized SAR value or normalized SAR distribution for the i^{th} active frequency band.

To assess RF exposure from transmissions using the second technology (e.g., 5G in 24 to 60 GHz bands, IEEE 802.11ad, 802.11ay, etc.), the wireless communication device may include multiple PD values and/or PD distributions for the second technology stored in the memory (e.g., memory 282 of FIG. 2 or memory 338 of FIG. 3). Each of the PD values or PD distributions may correspond to a respective one of multiple transmit scenarios supported by the wireless communication device for the second technology. The transmit scenarios may correspond to various combinations of antennas (e.g., antennas 252a through 252r of FIG. 2 or antenna 306 of FIG. 3), frequency bands, channels, and/or body positions, as discussed further below. In some examples, the stored PD includes a single value (e.g., a peak value determined based on the description below, or a sum of peak values).

The PD values and/or PD distribution (also referred to as a PD map) for each transmit scenario may be generated based on measurements (e.g., E-field measurements) performed in a test laboratory using a model of a human body. After generation, the PD distributions are stored in the memory to enable the processor (e.g., processor 280 of FIG. 2 or controller 336 of FIG. 3) to assess RF exposure in real time, as discussed further below. Each PD distribution may include a set of PD values, where each PD value may correspond to a different location (e.g., on the model of the human body).

The PD values in each PD distribution correspond to a particular transmission power level (e.g., the transmission power level at which the PD values were measured in the test laboratory). Since PD scales with transmission power level, the processor may scale a PD value or PD distribution for any transmission power level by multiplying each PD value (e.g., in the PD distribution) by the following transmission power scaler:

$$\frac{{Tx}_{c}}{{Tx}_{P D}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include one or more of the following: an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a DSI) indicating the location of the wireless communication device relative to the user's body location (head, trunk, away from the body, etc.), exposure category, and/or other parameters. In cases where the wireless communication device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or PD distributions for the subset of transmit scenarios. In this example, the PD values and/or PD distributions for each of the remaining transmit scenarios may be generated by combining two or more of the PD values and/or PD distributions for the subset of transmit scenarios, as discussed further below. In some cases, a subset of PD distributions generated via measurements may be used to validate PD distributions obtained from electromagnetic simulation of a wireless communication device, such that the PD distributions may be obtained from simulation for all the transmit scenarios supported by the wireless communication device.

For example, PD measurements may be performed for each one of the antennas to generate a PD value or PD distribution for each one of the antennas. In this example, a PD value or PD distribution for a transmit scenario in which two or more of the antennas are active may be generated by combining the PD values or PD distributions for the two or more active antennas.

In another example, PD measurements may be performed for each one of multiple frequency bands to generate a PD value or PD distribution for each one of the multiple frequency bands. In this example, a PD value or PD distribution for a transmit scenario in which two or more frequency bands are active may be generated by combining the PD values or PD distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or normalized PD distribution for a transmit scenario may be generated by combining two or more normalized PD values or normalized PD distributions. For example, a normalized PD value or normalized PD distribution for a transmit scenario in which two or more antennas are active may be generated by combining the normalized PD values or normalized PD distributions for the two or more active antennas. For the case in which different transmission power levels are used for the active antennas, the normalized PD value or normalized PD distribution for each active antenna may be scaled by the respective transmission power level before combining the normalized PD values or normalized PD distributions for the active antennas. The normalized PD value or normalized PD distribution for simultaneous transmission from multiple active antennas may be given by the following:

$$P {D}_{norm\_combined} = {\sum }_{i = 1}^{i = L} \frac{{Tx}_{i}}{{Tx}_{P D i}} \cdot \frac{P {D}_{i}}{P {D}_{lim}} \qquad ( 5 )$$

where PDₗᵢₘ is a PD limit, PD_{norm_combined} is the combined normalized PD value or combined normalized PD distribution for simultaneous transmission from the active antennas, i is an index for the active antennas, PDᵢ is the PD value or PD distribution for the i^{th} active antenna, Txᵢ is the transmission power level for the i^{th} active antenna, Tx_{PDi} is the transmission power level for the PD distribution for the i^{th} active antenna, and L is the number of the active antennas.

Equation (5) may be rewritten as follows:

$$P {D}_{norm\_combined} = {\sum }_{i = 1}^{i = L} \frac{T {x}_{i}}{T {x}_{P D i}} \cdot {PD}_{norm\_i} \qquad ( 6 a )$$

where PD_{norm_i} is the normalized PD value or normalized PD distribution for the i^{th} active antenna. In the case of simultaneous transmissions using multiple active antennas at the same transmitting frequency (e.g., MIMO), the combined normalized PD value or combined normalized PD distribution may be obtained by summing the square root of the individual normalized PD values or individual normalized PD distributions and computing the square of the sum, as given by the following:

$$P {D}_{norm\_combined \_MIMO} = {[ {\sum }_{i = 1}^{i = L} \sqrt{\frac{T {x}_{i}}{T {x}_{P D i}} \cdot {PD}_{norm\_i}} ]}^{2} . \qquad ( 6 b )$$

In certain aspects, a composite normalized PD distribution for a given transmitting band can be obtained by taking the maximum value at a given location (x, y, z) out of all normalized PD distributions for all the antenna configurations of a mmWave module. The composite normalized PD distribution can be used to represent the PD distribution for all antenna configurations of a mmW antenna module:

$$P {D}_{{norm}_{composite}} ( x , y , z ) = \frac{maximum \{ {PD}_{a} ( x , y , z ) , a = 1 … N \}}{P {D}_{lim}}$$

This PD_{norm_composite} can be used to substitute PD_{norm_i} in Equation (6a), where a represents all the N beams (or antenna configurations) supported by i^{th} mmWave module for a given frequency band. In such cases, Equation (6a) represents combining PD distributions if multiple frequency bands or mmWave antenna modules are active.

In another example, normalized PD values or normalized PD distributions for different frequency bands may be stored in the memory. In this example, a normalized PD value or normalized PD distribution for a transmit scenario in which two or more frequency bands are active may be generated by combining the normalized PD distributions for the two or more active frequency bands. For the case where the transmission power levels are different for the active frequency bands, the normalized PD value or normalized PD distribution for each of the active frequency bands may be scaled by the respective transmission power level before combining the normalized PD values or normalized PD distributions for the active frequency bands. In this example, the combined PD value or combined PD distribution may also be computed using Equation (6a) in which i is an index for the active frequency bands, PD_{norm_i} is the normalized PD value or normalized PD distribution for the i^{th} active frequency band, Txᵢ is the transmission power level for the i^{th} active frequency band, and Tx_{PDi} is the transmission power level for the normalized PD value or normalized PD distribution for the i^{th} active frequency band.

In certain cases, compliance with an RF exposure limit may be performed as a time-averaged RF exposure evaluation within a specified time window (T) (e.g., 2 seconds for 60 GHz bands, 100 or 360 seconds for bands ≤6 GHZ, etc.) associated with the RF exposure limit.

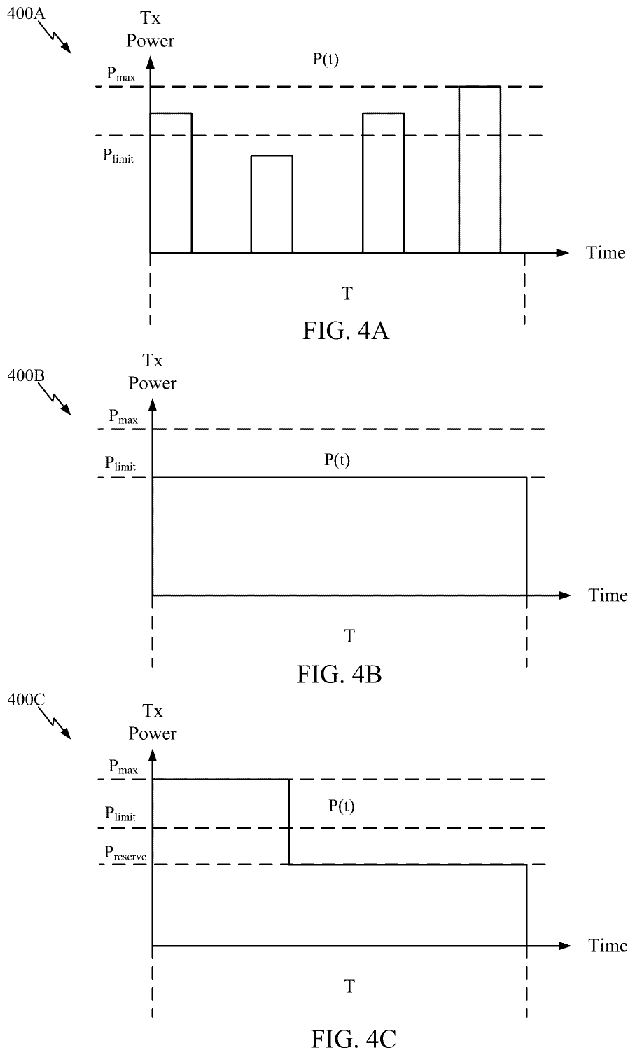

FIG. 4A is a graph 400A of a transmit power over time (P(t)) that varies over a time window (T) associated with the RF exposure limit, in accordance with certain aspects of the present disclosure. As an example, the instantaneous transmit power may exceed a maximum time-averaged transmit power level Pₗᵢₘᵢₜ in certain transmission occasions in the time window (T). That is, the transmit power may be greater than the maximum time-averaged transmit power level Pₗᵢₘᵢₜ. In certain cases, the UE may transmit at Pₘₐₓ, which is the maximum transmit power supported by the UE. In certain cases, the UE may transmit at a transmit power less than or equal to the maximum time-averaged transmit power level Pₗᵢₘᵢₜ in certain transmission occasions. The maximum time-averaged transmit power level Pₗᵢₘᵢₜ represents the time-averaged threshold in terms of transmit power for the RF exposure limit over the time window (T), and in certain cases, Pₗᵢₘᵢₜ may be referred to as the maximum time-averaged power level or limit, or in terms of exposure, the maximum time-averaged RF exposure level or limit. The graph 400A also illustrates gaps between transmission bursts, where the gaps represent periods during which no transmission was output from the device.

In certain cases, the transmit power may be maintained at the maximum time-averaged transmit power level (e.g., Pₗᵢₘᵢₜ) allowed for RF exposure compliance that enables continuous transmission during the time window. For example, FIG. 4B is a graph 400B of a transmit power over time (P(t)) illustrating an example where the transmit power is limited to Pₗᵢₘᵢₜ, in accordance with certain aspects of the present disclosure. As shown, the UE can transmit continuously at Pₗᵢₘᵢₜ in compliance with the RF exposure limit.

FIG. 4C is a graph 400C of a transmit power over time (P(t)) illustrating a time-averaged mode that provides a reserve power to enable a continuous transmission within the time window (T), in accordance with certain aspects of the present disclosure. As shown, the transmit power may be backed off from the maximum instantaneous power (Pₘₐₓ) to a reserve power (Pᵣₑₛₑᵣᵥₑ) so that the UE can continue transmitting at the lower power (Pᵣₑₛₑᵣᵥₑ) to maintain a continuous transmission during the time window (e.g., maintain a radio connection with a receiving entity). In FIG. 4C, the area between Pₘₐₓ and Pᵣₑₛₑᵣᵥₑ for the time duration of Pₘₐₓ may be equal to the area between Pₗᵢₘᵢₜ and Pᵣₑₛₑᵣᵥₑ for the time window T, such that the area of transmit power (P(t)) in FIG. 4C is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit. In some aspects, Pᵣₑₛₑᵣᵥₑ is set at a fixed power used to serve for a purpose (e.g., reserving power for certain communications). The transmit duration at Pₘₐₓ may be referred to as the burst transmit time (or high power duration). When more margin is available in the future (after T seconds), the transmitter may be allowed to transmit at a higher power again (e.g., in short bursts at Pₘₐₓ).

In some aspects, the UE may transmit at a power that is higher than the average power level, but less than Pₘₐₓ in the time-averaged mode illustrated in FIG. 4C. While a single transmit burst is illustrated in FIG. 4C, it will be understood that the UE may instead utilize a plurality of transmit bursts within the time window (T), for example, as described herein with respect to FIG. 4A, where the transmit bursts may be separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above the maximum average power level (e.g., Pₗᵢₘᵢₜ).

While FIGS. 4A-4C illustrate continuous transmission over a window, occasion, burst, etc., it will be understood that a duty cycle for transmission may be implemented. In such implementations, a transmit power may be zero periodically and maintained at a higher level (e.g., a level as illustrated in FIGS. 4A-4C) during other portions of the duty cycle. As used herein, the duty cycle of the transmission may refer to a portion (e.g., 5 ms) of a specific period (e.g., 500 ms) in which one or more signals are transmitted. In certain cases, the duty cycle may be standardized (e.g., predetermined) with a specific RAT and/or vary over time, for example, due to changes in radio conditions, mobility, and/or user behavior.

### Example RF Exposure Measurements

In certain cases, the RF exposure of a wireless device may be certified with a regulatory agency (e.g., Federal Communications Commission (FCC)). Spatial measurements may be taken with respect to a model (phantom) representing the human body, where the model may be filled with a liquid simulating human tissue. As discussed above, the UE 120 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure distributions (simulation and/or measurement) may then be generated per transmit antenna/configuration (beam) (as described above) on all evaluation surfaces/positions at all locations.

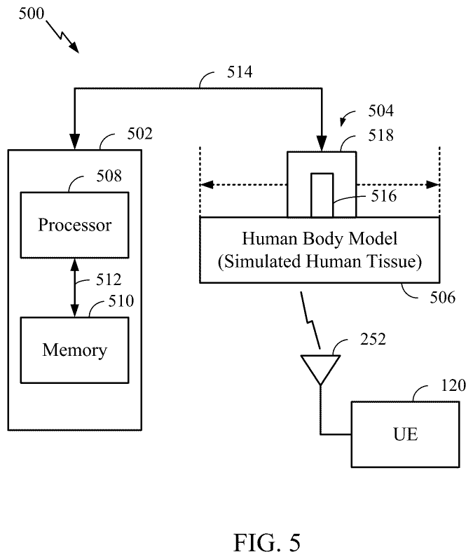

FIG. 5 is a diagram illustrating an example system 500 for measuring RF exposure values or distributions, in accordance with certain aspects of the present disclosure. As shown, the RF exposure measurement system 500 includes a processing system 502, a robotic RF probe 504, and a human body model 506. The RF exposure measurement system 500 may take RF measurements at various transmit scenarios and/or exposure scenarios associated with the UE 120. In some examples, these measurements may be used to generate a RF exposure map and assess suitable backoff factors for the transmit powers of the antenna(s) 252 in compliance with one or more RF exposure limits, as further described herein. The UE 120 may emit electromagnetic radiation via the antenna(s) 252 at various transmit powers, and the RF exposure measurement system 500 may take RF measurements via the robotic RF probe 504 (e.g., to determine RF exposure map(s) and/or backoff factors for the antenna(s) 252).

The processing system 502 may include a processor 508 coupled to a memory 510 via a bus 512. The processing system 502 may be a computational device such as a computer. The processor 508 may include a central processing unit (CPU), a graphics processing unit (GPU), a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 508 may be in communication with the robotic RF probe 504 via an interface 514 (such as a computer bus interface), such that the processor 508 may obtain RF measurements taken by the robotic RF probe 504 and control the position of the robotic RF probe 504 relative to the human body model 506, for example.

The memory 510 may be configured to store instructions (e.g., computer-executable code) that when executed by the processor 508, cause the processor 508 to perform various operations. For example, the memory 510 may store instructions for obtaining the RF exposure distributions associated with various RF exposure/transmit scenarios and/or adjusting the position of the robotic RF probe 504.

The robotic RF probe 504 may include an RF probe 516 coupled to a robotic arm 518. In some aspects, the RF probe 516 may be a dosimetric probe capable of measuring RF exposures at various frequencies such as sub-6 GHz bands and/or mmWave bands. The RF probe 516 may be positioned by the robotic arm 518 in various locations (as indicated by the dotted arrows) to capture the electromagnetic radiation emitted by the antenna(s) 252 of the UE 120. The robotic arm 518 may be a six-axis robot capable of performing precise movements to position the RF probe 516 to the location (on the human body model 506) of maximum electromagnetic field generated by the UE 120. In other words, the robotic arm 518 may provide six degrees of freedom in positioning the RF probe 516 with respect to the antenna(s) 252 of the UE 120 and/or the human body model 506.

The human body model 506 may be a specific anthropomorphic mannequin with simulated human tissue. For example, the human body model 506 may include one or more liquids that simulate the human tissue of the head, body, and/or extremities. The human body model 506 may simulate the human tissue for determining the maximum permissible transmission power of the antenna(s) 252 in compliance with various RF exposure limits.

In certain aspects, the RF exposure values or distributions associated with the UE 120 may be measured without the human body model 506. For example, the RF probe 516 may be an electric- or magnetic-field probe capable of estimating the SAR and/or PD in the free-space surrounding the UE 120.

While the example depicted in FIG. 5 is described herein with respect to obtaining RF exposure values or distributions with a robotic RF probe to facilitate understanding, aspects of the present disclosure may also be applied to other suitable RF probe architectures, such as using multiple stationary RF probes positioned at various locations along the human body model 506 or free-space.

### Example Compressed Radio Frequency Exposure Map

Multi-mode/multi-band UEs have multiple transmit antennas, which can simultaneously transmit in sub-6 GHz bands and bands greater than 6 GHz bands, such as mmWave bands. As described herein, the RF exposure of sub-6 GHz bands may be evaluated in terms of SAR, and the RF exposure of bands greater than 6 GHz may be evaluated in terms of PD. Due to the regulations on simultaneous exposure, the wireless device may limit maximum transmit power for both sub-6 GHz bands and bands greater than 6 GHz.

In some cases, the complete SAR and PD distributions may be used to determine a maximum allowed transmit power for a future time interval in accordance with a time-averaged RF exposure limit as described herein. Assuming n₁ sub-6 GHz antennas for SAR exposure, n₂ mmW antennas for mmW exposure, the sub-6 GHz radio is averaged over T1 time window, the mmWave radio is averaged over T2 time window, and these time windows are divided into p “Δt” time intervals and q “Δt” intervals, respectively (e.g., p=T1/Δt, q=T2/Δt), the total RF exposure may be determined according to the following expression:

$$Total . exposure ( x , y , z ) j = \qquad ( 7 )$$

$$\frac{1}{p} [ {\sum }_{j = 1}^{j = p - 1} total . norm . SARj ( x , y , z ) + norm . SARp ( x , y , z ) ] +$$

$$\frac{1}{q} [ {\sum }_{j = 1}^{j = q - 1} total . norm . PDj ( x , y , z ) + norm . PDp ( x , y , z ) ]$$

$$where :$$

$$total . norm . SARj ( x , y , z ) =$$

$${\sum }_{n 1 = 1}^{num sub 6 antennas in device} \frac{TX power of n 1 th antenna at jth Δ t}{P limit of n 1 th antenna} norm . SARn 1 ( x , y , z )$$

$$and$$

$$total . norm . PDj ( x , y , z ) =$$

$${\sum }_{n 2 = 1}^{num mmW antennas in device} \frac{TX power of n 2 th antenna at jth Δ t}{P limit of n 2 th antenna} norm . PDn 2 ( x , y , z )$$

At the jth Δt time interval, SAR and PD exposures can be calculated by summing the transmit powers for each radio normalized to the respective Pₗᵢₘᵢₜ of that radio and scaling the sum of the transmit powers with the normalized exposure maps (e.g., norm.SAR.exp.map(x, y, z) and norm.PD.exp.map(x, y, z)). Note that the p^{th} and q^{th} time intervals represent the future transmission. The wireless device computes the allocated margins for all sub-6 GHz radios in the p^{th} time interval and for all mmWave radios in the q^{th} time interval. Such a process ensures compliance with the time-averaged RF exposure limits. If the entire SAR and PD exposure maps are used for all or any of the six surfaces of a wireless device, computations to predict the future transmit powers for RF exposure compliance may be intensive and impractical for certain wireless devices, such as portable wireless devices.

Aspects of the present disclosure provide apparatus and methods for generating and/or using a compressed RF exposure map, where the RF exposure map may be representative of maximum RF exposures exhibited in particular regions associated with the wireless device for certain individual radios and/or combinations of radios. The RF exposure map may be reduced to maximum RF exposures in certain regions, such that the wireless device evaluates RF exposure compliance across the regions identified for the RF exposure map. In certain aspects, the RF exposure map may be representative of the RF exposure in terms of SAR and/or PD.

Note, as used herein, a region of an RF exposure map may be representative of an actual point or area of the wireless device or may not be representative of an actual point or area of the wireless device. In some cases, for example, a region of the RF exposure map may be representative of one or more points on the wireless device. For instance, a region may be representative of a single point on the wireless device or a set of points on the wireless device. In cases where the region is representative of a set of points on the wireless device, the set of points may be a set of contiguous points or a set of non-contiguous (or scattered) points. In some cases, a region of the RF exposure map may be representative of a collection of a set of points on the wireless device, where each respective set of points corresponds to a different area (within the region) of the wireless device. Each respective set of points within the collection may include contiguous points or non-contiguous points. In some cases, a region of the RF exposure map may include one or more contribution values. The contribution value(s) may not represent an actual point on the wireless device or RF exposure map. For example, the contribution value(s) may be based on an overlap in exposure distribution among different technologies/antennas (e.g., radio, antenna (or antenna module), beam, band, or combination thereof) under consideration. In some cases, the contribution value(s) may be determined from a simulation of the various exposure/transmit scenarios. For example, assuming a user, manufacturer, and/or service provider decides to reduce maps of multiple antennas, the interactions among the antennas may be evaluated during simulation to determine a contribution matrix with contribution value(s) that ensure RF exposure compliance.

The apparatus and methods for generating and using the RF exposure map described herein may facilitate improved wireless communication performance (e.g., improved signal quality at the receiver, lower latencies, higher throughput, etc.). The apparatus and methods for generating and using the RF exposure map described herein may also enable improved processing performance, for example, due to the reduced memory size used by the RF exposure map and/or the reduced number of computations used to perform the RF exposure evaluation to satisfy time-averaged RF exposure compliance during simultaneous transmission scenarios.

Exposure maps associated with a wireless device may be generated for various combinations of transmission and/or exposure scenarios, such as an exposure map per antenna (and/or antenna module) of the wireless device. Assuming there are m1 regions identified for the RF exposure map, instead of performing calculations on full exposure distributions for all of the exposure maps associated with the antennas, m1 regions may be considered for each exposure distribution, for example, according to the following expressions:

$$total . norm . SARj ( m 1 ) =$$

$${\sum }_{n 1 = 1}^{num sub 6 antennas in device} \frac{TX power of n 1 th antenna at jth Δ t}{P limit of n 1 th antenna} norm . SARn 1 ( m 1 )$$

$$and$$

$$total . norm . PDj ( m 1 ) =$$

$${\sum }_{n 2 = 1}^{num mm W antennas in device} \frac{TX power of n 2 th antenna at jth Δ t 1}{P limit of n 2 th antenna} norm . PDn 2 ( m 1 )$$

In the above equations, the initial SAR/PD matrix size is significantly reduced through the process described herein with minimal compromise to achievable transmit power level (e.g., ˜<0.5 decibels (dB) reduction compared to using the full exposure distribution approach for most cases). For example, the full exposure distribution associated with a device of size 21 centimeters by 16 centimeters with eight antennas and with a 1 mm resolution may have more than 200,000 points to perform the calculations on a single surface. In some cases, the compressed RF exposure map described herein may have less than one hundred (e.g., ≤88) regions to achieve similar results as the full exposure distribution approach, for example, with a small (e.g., about 0.5 dB) compromise on transmit power.

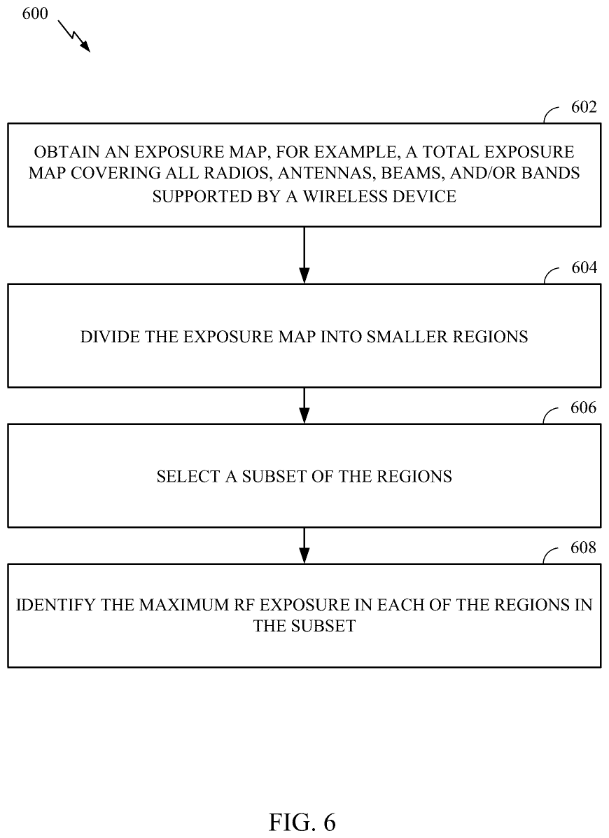

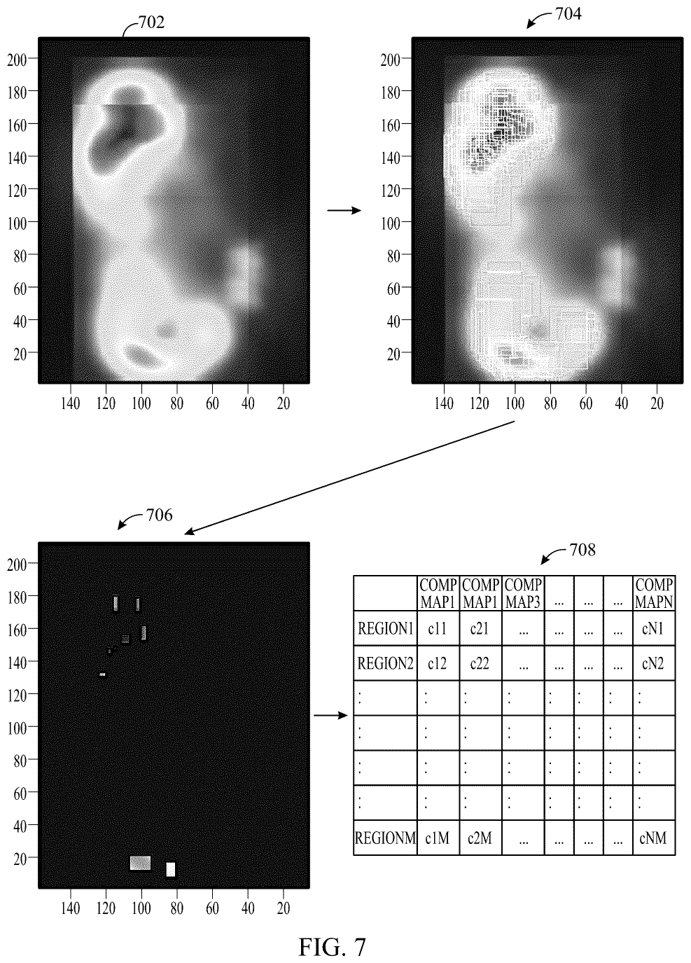

FIG. 6 is a flow diagram illustrating example operations 600 for generating a compressed RF exposure map. The operations 600 may be performed using a processing system (e.g., the processing system 502) or another computational device. As described herein with respect to the operations 600, FIG. 7 is a diagram illustrating the progression of generating the compressed RF exposure map from one or more RF distributions.

The operations 600 may optionally begin at block 602, where the processing system may obtain an exposure map (e.g., the total normalized exposure map 702), for example, covering the exposure exhibited by all (or at least some) of the radios, antennas (or antenna modules), beams, and/or bands supported by a wireless device. The processing system may obtain multiple composite normalized exposure maps associated with multiple exposure maps, for example, by adding the individual normalized maps. The obtained exposure map may be a total exposure map derived from a set of normalized composite exposure maps (e.g., normalized RF exposure distributions). The composite exposure maps may be normalized with respect to the respective RF exposure limit (e.g., SAR limit and/or PD limit). In some cases, the processing system may obtain the RF exposure distributions using the RF exposure measurement system 500, for example. In certain aspects, the RF exposure distributions may be generated via simulations, such as a simulation of the various exposure/transmit scenarios using a model of the human body being exposed to electromagnetic radiation from a wireless device. The set of normalized exposure maps may represent the exposure exhibited by sub-6 GHz and/or mmWave antennas and supported by the wireless device, for example.

At block 604, the processing system may divide (e.g., segment) the total exposure map into smaller regions, such as the regions 704. For example, the processing system may identify a region for each of the maximum contribution of each radio, antenna (or antenna module), beam, and/or band in the regions allowing for the RF distribution to be reduced to regions totaling the number of maximum contributions of each radio, antenna (or antenna module), beam, and/or band in the regions.

At block 606, the processing system may select a subset of the regions (e.g., the subset of regions 706). The processing system may perform an iterative process to determine if the maximum RF exposures associated with a subset of the regions provides RF exposure compliance. If RF exposure compliance is not satisfied for the selected subset of the regions, the processing system may re-select the regions included in the subset, for example, by adding one or more regions to the subset. The regions selected for the subset may be based on certain constraints, such as a wireless performance constraint (e.g., a tolerance value) and/or a memory constraint (e.g., size of the RF exposure map).

At block 608, the processing system may identify the maximum RF exposure in each of the regions in the subset. In some cases, the processing system may store the maximum RF exposures associated with the subset of regions as a table (e.g., the table 708). After identifying the subset of regions (e.g., m regions), the processing system may obtain the reduced normalized exposure maps within the selected subset of regions (m regions) for the composite maps used to create the total exposure map (e.g., n normalized exposure maps obtained at block 602). For example, the maximum RF exposures (e.g., m×n values) in the subset of regions of each of the composite maps may be determined according to the following expression:

$$normalized exposure map ( exposure map i , region j ) = max ( {exposure\_map}_{i} ( x , y , z ) , ( x , y , z ) ϵ region j ) \qquad ( 8 )$$

where, i is a sequence from 1 to n, and j is a sequence from 1 to m.

In certain aspects, the exposure distributions obtained at block 602 may be determined (e.g., measured or simulated) for all antennas in low, mid, and high channels for all supported bands. As previously described herein, an RF exposure distribution may include the RF exposure associated with various transmit scenarios that correspond to specific frequency bands and/or human body positions relative to an antenna or antenna module. For example, the RF exposure distributions may be represented by the expression: RFexp(s, x, y, z, i), where s represents a particular surface or position, (x, y, z) represent a given location, and i represents a particular transmit configuration, such as a specific antenna or transmit beam. In certain cases, a transmit antenna may support multiple bands, so multiple RF exposure distributions for each band/channel (low/mid/high) may be available for a specific transmit antenna. In that case, the RF exposure distribution for a specific transmit antenna can represent the maximum exposure out of all technologies/bands/channels supported by the transmit antenna at each location/exposure surface. In certain cases, a transmit antenna module may support multiple antenna configurations (or beams), so that the RF exposure distribution for a specific transmit antenna module can represent the maximum exposure out of all beams supported by the transmit antenna module at each location/exposure surface.

A composite map can be determined per antenna per band (e.g., maximum exposure of low, mid, and high channels at each location (x, y, z) across a surface). A composite map can be determined per antenna (e.g., a maximum exposure of all bands for a given antenna). Assuming a given antenna is capable of supporting 40 bands, those bands can be divided into subsets of bands. For example, a first band b1 may include band1, band5, and band8 (e.g., b1={band1, band5, and band8}), a second band b2 may include band3 and band9 (e.g., b2={band3, band9}), and a third band b3 may include band2 and band32 (b3={band2, band32}), etc., where the superset of b1+b2+b3+ . . . =40 bands. The composite maps can be determined per antenna per subset of bands. The set of composite maps that cover all (or at least some) antennas and all (or at least some) bands can include: (1) composite maps per antenna (or antenna module), (2) composite maps per antenna per band, or (3) composite maps per antenna per subset of bands, or a combination thereof.

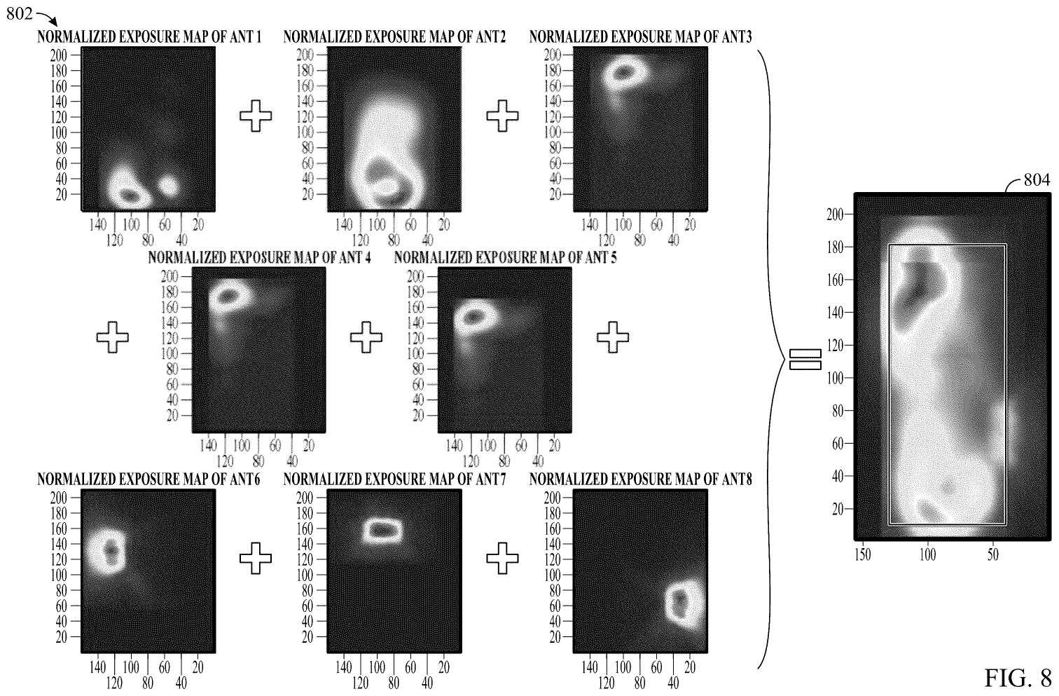

FIG. 8 is a diagram illustrating eight normalized composite maps 802 per antenna being added together to obtain a total exposure map 804. In this example, each of the composite maps 802 may be normalized with the respective RF exposure limit (e.g., SAR limit or PD limit) to 1.0, and the total exposure map 804 may have points that are greater than 1.0 due to finite overlaps between the distributions of composite maps.

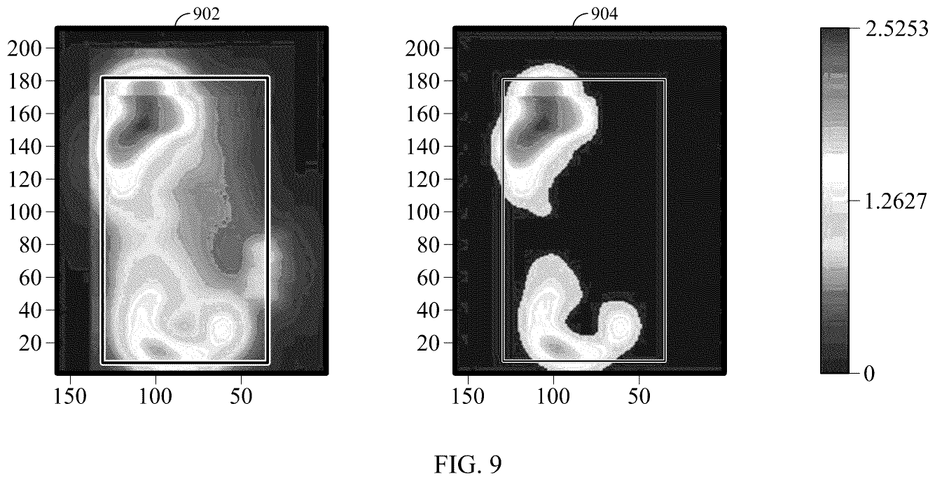

To divide (e.g., segment) the total exposure map into regions at block 604, the processing system may perform various activities. The processing system may remove compliant locations from the total exposure map. For example, to remove the compliant locations, the processing system may set the values associated with locations having a normalized value less than or equal to a threshold (e.g., 1.0) to a default value, such as zero. FIG. 9 illustrates an example total exposure map 902 and an updated version of the total exposure map 904 with the compliant locations set to a specific value (e.g., zero). Note, in other aspects, instead of dividing the total exposure map into regions, at block 604, the processing system may consider certain regions of individual exposure maps (e.g., composite maps 802) as regions, such as regions 704. Additionally, the processing system may evaluate contributions from different technologies/antennas under consideration when determining the regions, such as regions 704.

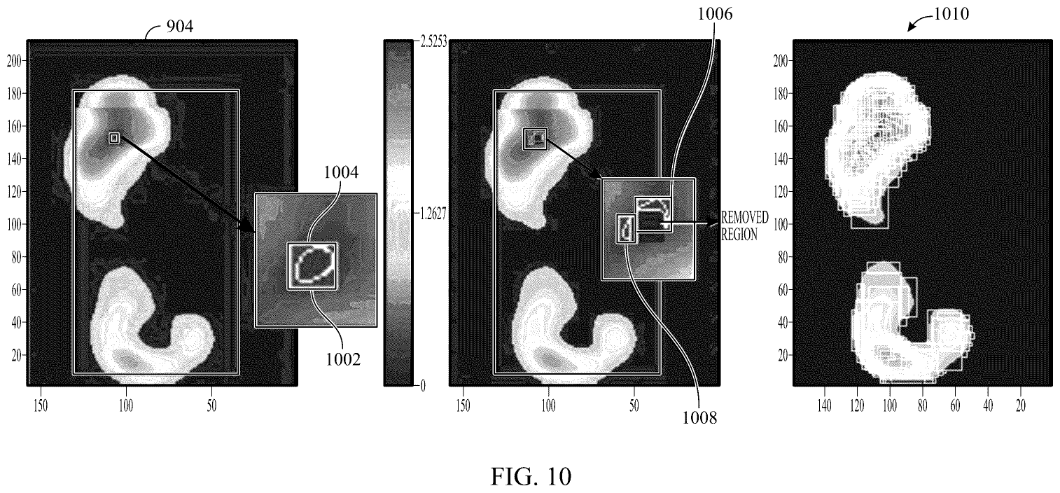

The processing system may identify one or more non-compliant region(s) (e.g., a region having an exposure value greater than or equal to 1.0) in the updated total exposure map. FIG. 10 illustrates examples of identifying non-compliant regions until all of the non-compliant areas are covered with identified regions 1010. For example, the processing system may identify a non-compliant region (e.g., the non-compliant region 1002) as a region having a peak exposure value among the exposure values in the updated total exposure map. The processing system may temporarily remove the identified region from the total exposure map for subsequent division of the total exposure map. The processing system may repeat identifying the next non-compliant region(s) (e.g., the non-compliant regions 1006, 1008) with the peak exposure value until all of the non-compliant regions are covered by at least one region. For example, the processing system may remove the region(s) selected in the previous iteration from the non-compliant map (e.g., the boundary 1004 of the region 1002). The processing system may repeat identifying the non-compliant region(s) and removing the non-compliant region(s) until all the non-compliant regions (e.g., the non-compliant regions 1010) are identified. When all the non-compliant regions are covered, the processing system may save the identified regions. The processing system may obtain the maximum contributions of the exposure maps in each of the regions and save the corresponding contributions.

In certain aspects, the processing system may apply a threshold contour to identify a non-compliant region (e.g., the non-compliant region 1002), such as a 95% contour. The contour level may be any non-zero value less than 100%. A 95% contour may provide an efficient processing time to run the algorithm. The contour represents the boundary inside which all the points have a value higher (greater) than the contour threshold (e.g., product of the contour and the maximum value of the total exposure map).

The processing system may approximate the boundary of the contour as a rectangle or any other suitable polygon. For example, the processing system may determine the rectangular boundary (e.g., the boundary 1004) that encompasses the contour boundary of the non-compliant region. Any polygonal shape or the contour shape itself could be used for the boundary of the non-compliant region. Other shapes may use more memory to store the region boundary, whereas a rectangular boundary may use values of two start coordinates, a length, and a breadth. Strategically selecting or fine tuning regions (e.g., size and shape of exposure contours) may provide improved performance in terms of backoff factors as further described herein.

The processing system may identify the maximum contribution of each antenna within the non-compliant region, the worst interactions among antennas (e.g., maximum contribution among sets of antennas) within the non-compliant region, or a combination thereof. The processing may determine if the sum of the maximum contributions from all the antennas is less than or equal to the maximum value of the total exposure map plus a tolerance, where the tolerance value could vary based on criteria for the number of reduced regions. The tolerance value may be used to adjust the amount of power reduction obtained with the compressed RF exposure map. A higher tolerance used for generating the compressed RF exposure map will result in fewer identified regions in the subset, which will use fewer processing resources (e.g., instructions per second and/or memory) and provide a higher backoff, as further described herein. A lower tolerance value used for generating the compressed RF exposure map will result in more identified regions in the subset, which will use more processing resources and provide a lower backoff. The number of regions in the subset can be controlled by specifying an acceptable tolerance, which may correspond to the expected performance compared to a full resolution map.

If the condition is not met (e.g., the maximum contributions>maximum value+tolerance), the contour level is increased (e.g., 96%) to a value greater than the starting contour, and the boundary of the non-compliant region is re-determined using the updated contour level. Note while aspects herein describe increasing a contour level, in general, aspects may change the size of the area of exposure maps under consideration until the condition is met. If the condition is met (e.g., the maximum contributions<maximum value+tolerance), the identified non-compliant region is stored in memory along with the maximum contributions of each exposure map within the region, and this identified region is removed for subsequent division of the total exposure map. If two or more non-compliant regions are identified in an iteration, all of the non-compliant regions may be verified to satisfy the condition. In some cases, the non-compliant regions satisfying the condition could be considered valid and removed without discarding all the identified rectangles.

To determine the subset of the non-compliant regions at block 606, the processing system may perform an iterative process to select a subset of the non-compliant regions that is sufficient to demonstrate RF exposure compliance for the full resolution maps. Multiple points in each normalized map are represented by a point in the subset of regions. The number of subset regions selected may vary based on various criteria, such as the constraints placed on the device performance (e.g., tolerance value in the algorithm) and memory usage. This selection may be performed during a calibration process, for example in a factory or manufacturing facility, or during a test or compliance process. The selection may instead be performed on a wireless device, for example due to settings input by a manufacturer or software developer, or based on user input. During the iterative process, backoff information (e.g., backoff factors) may be computed using m1 points for i exposure maps, for all p ON/OFF scenarios associated with the antennas, where p may be equal to 2ⁱ⁻¹. For a given q^{th} ON/OFF scenario, where a map is either ON=1 or OFF=0, represented by on_off(q), the compressed total normalized exposure may be verified as follows:

$$Total . norm . comp . map q ( j ) = \qquad ( 9 )$$

$${\sum }_{k = 1}^{i} \{ bf ( q , k ) \cdot on\_off ( q ) \cdot norm . reduced . map ( k , j ) \} ,$$

$$Total . norm . comp . map q ( 1 to m 1 ) \leq 1$$

where bf(q, k) is a backoff factor associated with an antenna, antenna module, or an antenna group; j is a sequence from 1 to m1; and norm.reduced.map(k,j) is the exposure map reduced to the subset of regions. The backoff factor(s) may be adjusted until the total normalized exposure satisfies the threshold (e.g., ≤1).

As used herein, a backoff factor may be a specific number representing a fraction (or portion) of a maximum transmit power level supported by a UE, such as a number in the range of 0 to 1. For example, the processing system may generate normalized distributions of the RF exposure distributions, generate a normalized composite map of the normalized distributions for each of the antennas (or antenna modules or antenna groups), and generate a total of the normalized composite maps for all of the antennas based on a backoff factor associated with each of the antennas (or antenna modules or antenna groups). As an example, the backoff factor bf may be between [0, 1] for each antenna, such that the maximum permissible transmit power for each antenna equals the respective backoff factor times the transmit power limit of the antenna group (e.g., bf*Tx_power_limit), where bf=1 represents no backoff, where bf=0.3 signifies to operate the antenna group at 30% of the transmit power limit, and where the transmit power limit may be the maximum transmit power supported by that particular antenna and/or antenna group.

For each of the ON scenarios (e.g., q=1) among p ON/OFF scenarios, the backoff factors bf(q,k) may be verified as being valid for full resolution maps using the following expressions:

$$Full . resolution . total . norm . comp . map q ( x , y , z ) = \qquad ( 10 )$$

$${\sum }_{k = 1}^{i} \{ bf ( q , k ) \cdot on\_off ( q ) \cdot norm . full . resolution . map ( k , x , y , z ) \} ,$$

$$Full . resolution . total . norm . comp . map q ( x , y , z ) \leq 1 .$$

The processing system may determine that m points of the selected subset of regions meet the above criteria for all p ON/OFF combinations to confirm that selected regions are representative of the full resolution map. The subset of regions may be selected such that the backoffs, which are determined using the subset of regions, provide RF exposure compliance for full resolution maps. The number of regions in the subset may be dictated by performance limitations such as processing capabilities. Various approaches can be used to reduce the full resolution maps into subset of regions such that the backoffs obtained using subset, when applied on the full resolution maps, demonstrates RF exposure compliance.

In certain aspects, the subset of non-compliant regions may be adjusted based on the backoff information. For example, the processing system may start with the initial non-compliant regions (e.g., the rectangles determined at block 604) and check if the backoff value obtained for the region is sufficient to handle all (or at least some of) the antenna on/off situations when the backoff is applied to full resolution maps. If the backoff value is failing for a particular test case, the processing system may adjust the region to include the maximum exposure point for the test case. For example, the processing system may find the region to which the maximum exposure point belongs and include that region in the backoff calculation. The processing system may repeat such adjustments until the calculated backoff value is valid for all (or at least some of) the antenna on/off situations. Following this adjustment, all the regions in the subset can satisfy RF exposure compliance. The processing system may store the maximum contribution from each antenna in the identified regions in a matrix (or table) format.

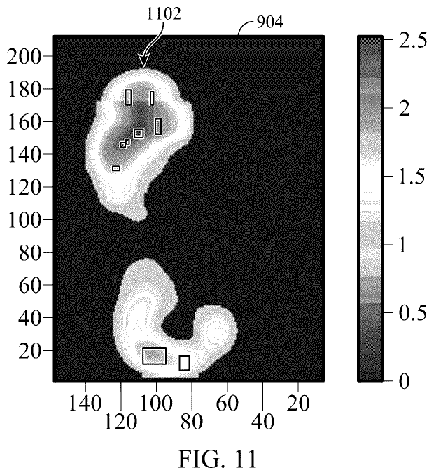

FIG. 11 illustrates an example of a subset of non-compliant regions 1102 selected for the compressed RF exposure map, for example, as selected in block 606. For example, the subset of non-compliant regions 1102 may be determined using the backoff verification described herein.

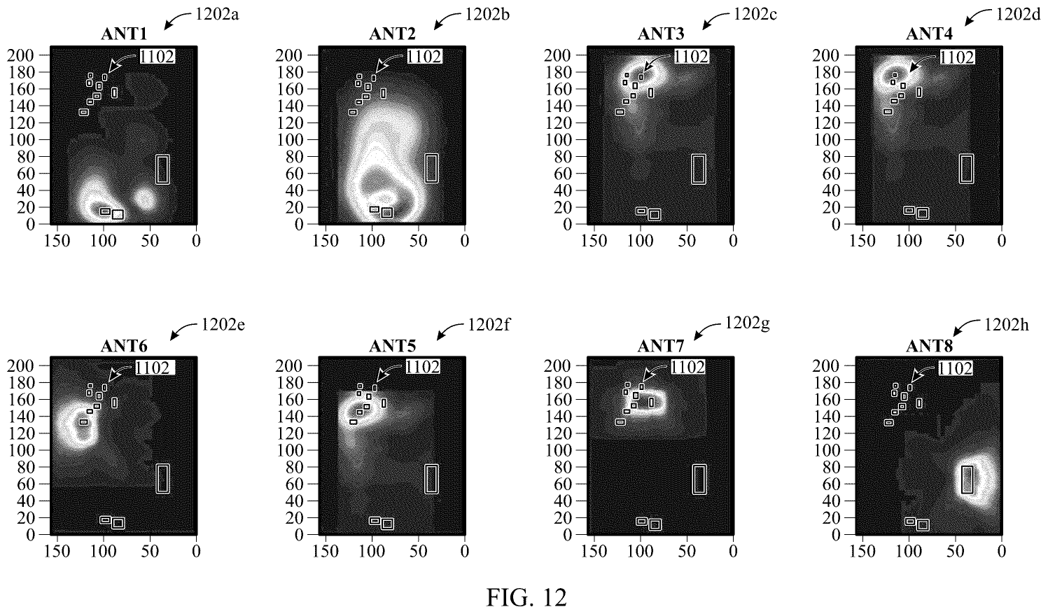

FIG. 12 illustrates examples of composite maps 1202a-h and the subset of non-compliant regions, where each of the composite maps 1202a-h is associated with a contribution from a different antenna (or antenna module). As described herein, the maximum value inside the identified regions 1102 may be stored for each of the different composite maps 1202a-h to perform time-averaged RF exposure compliance, for example, as described herein with respect to FIGS. 4A-4C.

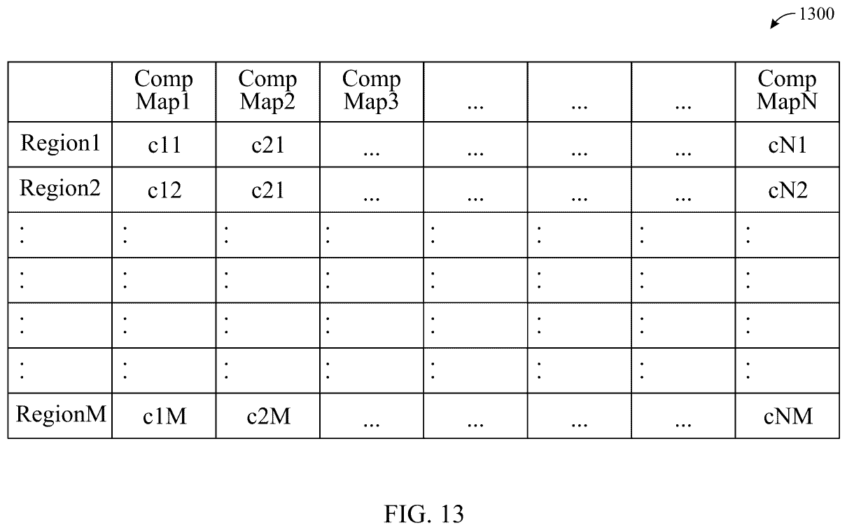

FIG. 13 illustrates an example table 1300 of maximum RF exposure values associated with a particular map per region (e.g., the subset of regions). In this example, the table may have a size of M by N table, where maximum contributions from N composite maps within each identified region are stored for M identified regions.

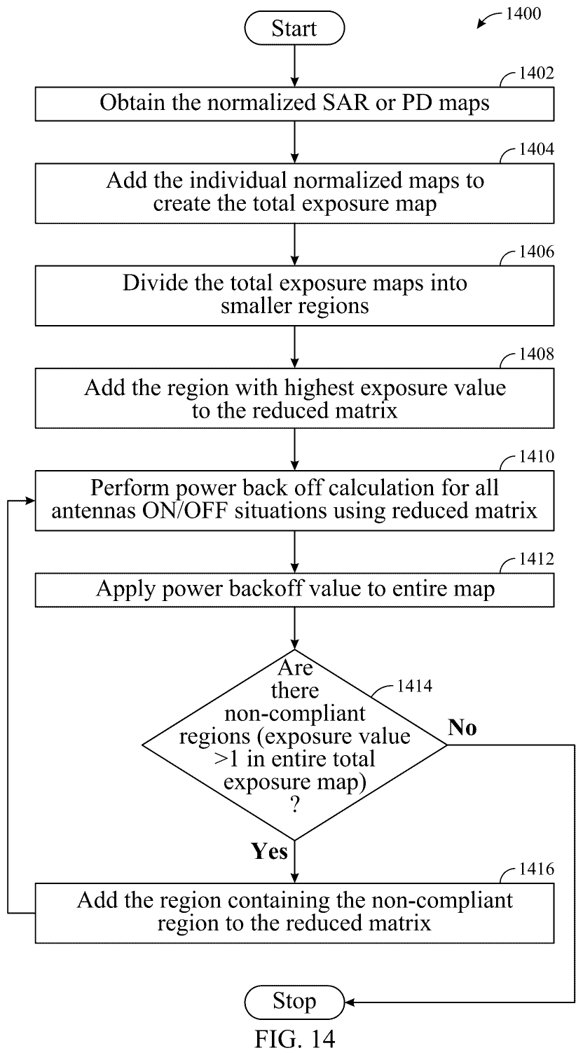

FIG. 14 is a flow diagram illustrating example operations 1400 for generating an RF exposure map. The operations 1400 may be performed using a processing system (e.g., the processing system 502) or any other computational device. The operations 1400 may optionally begin at block 1402, where the processing system may obtain normalized composite exposure (e.g., SAR and/or PD) maps per radio, antenna (or antenna module), beam, and/or band supported by a wireless device.

At block 1404, the processing system may combine the composite exposure maps to generate a total exposure map (e.g., the total exposure map 804). To combine the composite exposure maps, the processing system may add the composite exposure maps together to form the total exposure map (e.g., the sum of the composite exposure maps).

At block 1406, the processing system may divide the total exposure map into smaller regions. For example, the processing system may identify non-compliant regions in the total exposure map using the contour and removal approach described herein with respect to FIGS. 9 and 10.

At block 1408, the processing system may add the regions that include the highest exposure value for each of the composite exposure maps to a reduced matrix (e.g., a compressed RF exposure map represented as a table or matrix), for example, as described herein with respect to FIGS. 12 and 13.

At block 1410, the processing system may perform a power backoff calculation for ON/OFF situations associated with the antennas using the reduced matrix. The processing system may determine backoff information (e.g., backoff factor values) associated with the antennas using the reduced matrix.

At block 1412, the processing system may apply the power backoff value to a full resolution exposure map (e.g., the total exposure map 902).

At block 1414, the processing system may determine whether there are non-compliant regions in the full resolution exposure map with the backoff values applied.

At block 1416, if a non-compliant region is identified in the full resolution exposure map, the processing system may add the region to the reduced matrix. If a non-compliant region is not identified in the full resolution exposure map, the processing system may consider the reduced matrix to be complete.

The operations for generating the compressed RF exposure map described herein may be performed on any set of SAR and/or PD distributions. The compressed RF exposure map may be generated on any number of composite maps, the distribution of exposure in those composite maps, and the overlaps in the distribution. The operations described herein may be used to reduce any normalized SAR or normalized PD map combinations.

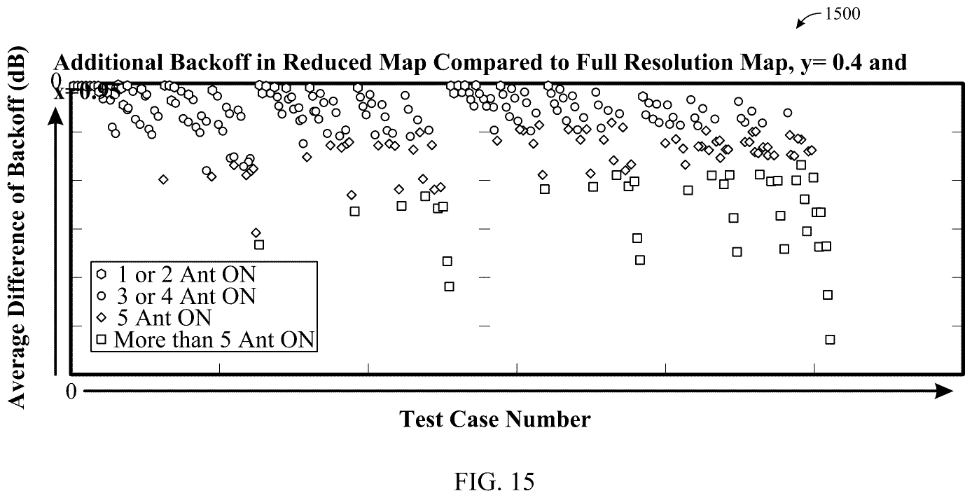

FIG. 15 is an example plot 1500 illustrating the average backoff difference in decibels for different ON/OFF combinations of antennas across different test cases. The backoff difference is between backoffs calculated with the reduced exposure map (e.g., the table 1300 depicted in FIG. 13) and backoffs calculated with the full exposure map. In this example, the backoffs are evaluated from a compressed exposure map and full resolution exposure map derived from composite exposure maps associated with eight antennas, where the total ON/OFF combinations equals 255 (e.g., 2⁸−1), the tolerance is equal to 0.4 (y=0.4), and the contour is equal to 0.95 (x=0.95). The compressed exposure map may have m regions, in this example, m equals 11. The delta between the above two approaches for determining backoffs shows the minimal performance impact encountered with the compressed RF exposure map. The performance loss may be inversely proportional to the number of regions m included in the compressed RF exposure map. For example, if m is equal to one, all distributions are represented by the highest exposure value, which would be equivalent to all antennas being collocated. As m approaches the number of points in the full resolution map, the performance loss will decrease and the processing resources will increase (e.g., number of computations and/or memory size). As demonstrated in the graph, there is no performance loss in cases of single transmit scenarios (e.g., only one composite map is active) as there is no overlap with other composite maps, and the performance loss is minimal for other transmit scenarios. For simultaneous scenarios with five antennas or less active, the average additional backoff is less than 1 dB. The compressed RF exposure map may reduce the number of computations significantly (e.g., by a factor of 3,000).

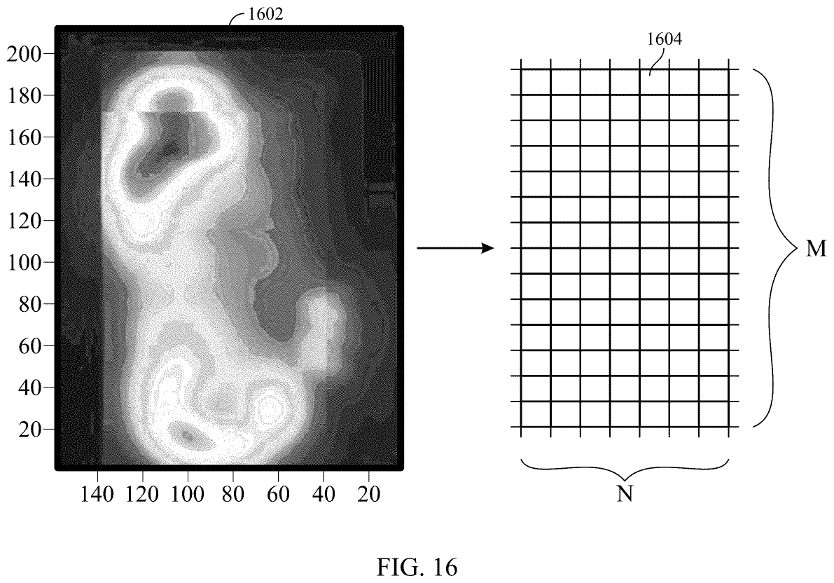

In certain aspects, the RF exposure map may be divided into multiple regions, and the RF exposure map may be compressed by obtaining the maximum RF exposure in each of the regions. For example, FIG. 16 is a diagram illustrating an RF exposure map 1602 being segmented into multiple regions 1604. In this example, the RF exposure map 1602 may be compressed by identifying a maximum RF exposure value for each of the regions 1604, where the maximum RF exposure values in the regions 1604 may be representative of the compressed RF exposure map. The regions 1604 may be arranged in a grid or matrix (e.g., M×N grid) across the RF exposure map 1602. In some aspects, each of the regions 1604 may have the same size or dimensions.

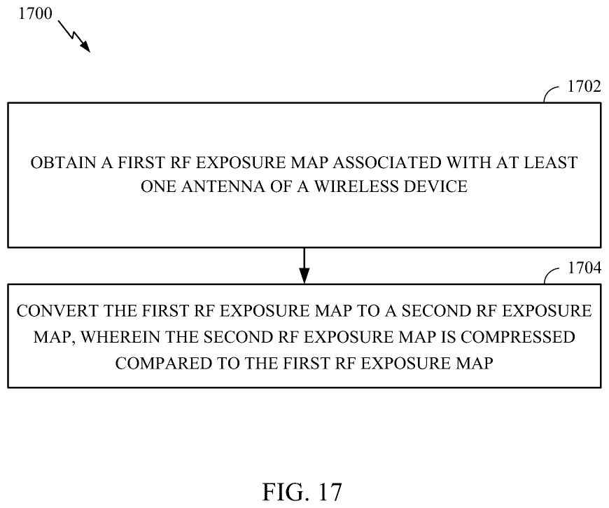

FIG. 17 is a flow diagram illustrating example operations 1700 for generating an RF exposure map. The operations 1700 may be performed using a processing system (e.g., the processing system 502) or any other computational device.

The operations 1700 may optionally begin at block 1702, where the processing system may obtain a first RF exposure map (e.g., the total exposure map 804) associated with at least one antenna of a wireless device. In certain aspects, the first RF exposure map may be obtained by measuring RF exposure using the measurement system 500. In some cases, the first RF exposure map may be simulated using a model of the radiation patterns emitted from a wireless device.

At block 1704, the processing system may convert the first RF exposure map to a second RF exposure map, where the second RF exposure map is compressed compared to the first RF exposure map. For example, the second RF exposure map may represent maximum normalized exposure levels for a subset of regions in the first RF exposure map. To convert the first RF exposure map to the second RF exposure map, the processing system may generate a look-up table (e.g., the table 1300 depicted in FIG. 13) of exposure contributions across different regions using the first RF exposure map. In certain aspects, the compressed RF exposure map may correspond to maximum RF exposure values associated with different regions, for example, as described herein with respect to FIG. 16.

In certain aspects, the first RF exposure map may be derived from composite RF exposure maps. For example, to obtain the first RF exposure map, the processing system may obtain a plurality of RF exposure maps (e.g., the normalized composite maps 802), where each of the RF exposure maps is representative of an RF distribution for a different antenna of the wireless device. The processing system may combine the plurality of RF exposure maps to form the first RF exposure map, for example, as described herein with respect to FIG. 8. The first RF exposure map may include normalized RF exposure contributions (e.g., normalized composite maps) from a plurality of antennas of the wireless device. The first RF exposure map is indicative of RF exposure contributions from a plurality of antennas of the wireless device across one or more surfaces (e.g., a top, bottom, front, back, left, and/or right) of the wireless device. The first RF exposure map may be representative of the RF exposure contributions across one surface of the wireless device or a plurality of surfaces, where the distributions for multiple surfaces of the wireless device can be represented in a single RF exposure map. The first RF exposure map may include a representation of the RF exposure contributions arranged in at least two dimensions (e.g., x-axis and y-axis).

For aspects, the processing system may segment the first RF exposure map into a plurality of regions (e.g., the subset of non-compliant regions 1102), for example, as described herein with respect FIGS. 10 and 11. The processing system may select, for each of the regions, a maximum RF exposure value among a plurality of values in the respective region. For example, the processing system may select, per region, the maximum RF exposure value from each of the composite exposure maps associated with the total exposure map. The processing system may generate the second RF exposure map as the selected maximum RF exposure values in the regions, for example, as described herein with respect to FIG. 13 and/or FIG. 16. In some cases, the compressed RF exposure may be the selected maximum RF exposure values in the regions.

For certain aspects, the processing system may perform an iterative process to convert the first RF exposure map, for example, as described herein with respect to FIGS. 8-14. The processing system may determine a total normalized composite RF exposure map for a plurality of antennas based on a backoff factor and the first RF exposure map at a reduced resolution (e.g., using the subset of regions 1102), for example, according to Expression (9). For example, the processing system may adjust the backoff factor until the total normalized composite RF exposure satisfies a threshold (e.g., ≤1). The processing system may re-segment the first RF exposure map into the plurality of regions until the backoff factor satisfies a threshold for computing the total normalized composite RF exposure map at a full resolution of the first RF exposure map, for example, according to Expression (10).

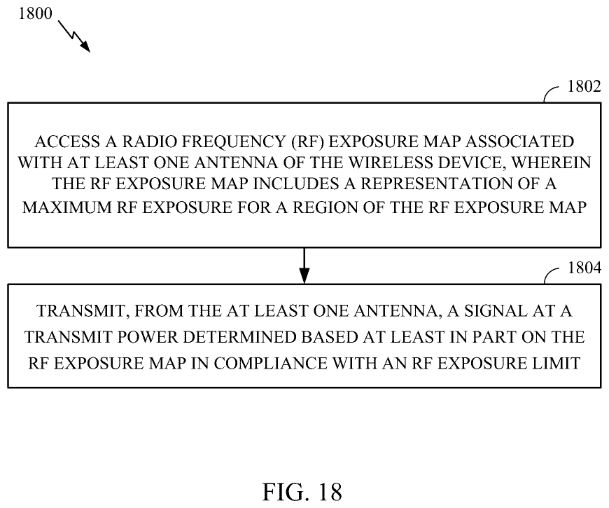

As further described herein with respect to FIG. 18, a wireless device may use the compressed RF exposure map to determine a transmit power in compliance with a time-averaged RF exposure limit. For example, a wireless device may access the second RF exposure map associated with the at least one antenna of the wireless device, where the second RF exposure map includes a representation of a maximum RF exposure for a region. The wireless device may transmit, from the at least one antenna, a signal at a transmit power determined based at least in part on the second RF exposure map in compliance with an RF exposure limit (e.g., a time-averaged SAR limit).

FIG. 18 is a flow diagram illustrating example operations 1800 for wireless communication, in accordance with certain aspects of the present disclosure. The operations 1800 may be performed, for example, by a wireless device (e.g., the UE 120a in the wireless communication network 100). The operations 1800 may be implemented as software components that are executed and run on one or more processors (e.g., controller/processor 280 of FIG. 2). Further, the transmission and/or reception of signals by the wireless device in the operations 1800 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals.

The operations 1800 may optionally begin, at block 1802, where the wireless device may access an RF exposure map (e.g., a compressed RF exposure map as represented by the table 1300 depicted in FIG. 13) associated with at least one antenna (e.g., antennas 252 of FIG. 2) of the wireless device, where the RF exposure map includes a representation of a maximum RF exposure for a region of the RF exposure map, such as at least one of the regions 1102 in FIG. 11. The wireless device may access the RF exposure map as a table or other data structure via memory. For example, the RF exposure may be stored in memory (e.g., the memory 282 and/or the memory 338), and the wireless device may access the memory to obtain the RF exposure map. The antenna may include multiple antenna elements operable at a range of frequency bands (e.g., sub-6 GHz and/or mmWave frequency bands).

At block 1804, the wireless device may transmit, from the at least one antenna, a signal at a transmit power determined based at least in part on the RF exposure map in compliance with an RF exposure limit. In certain cases, the wireless device may transmit via a single antenna or multiple antennas simultaneously, where simultaneous transmissions may include transmissions in the same transmission occasion, time interval, or time window associated with the RF exposure limit. In some cases, the wireless device may transmit via a single radio or multiple radios simultaneously. For example, the wireless device may transmit via any combination of LTE/NR radio, WiFi radio (e.g., IEEE 802.11 channels), and/or Bluetooth radio, simultaneously. In some cases, the wireless device may have transmitted via multiple radios within the same time window(s) defined by the regulator or standard for averaging RF exposure. For example, the wireless device may transmit via any (2G/3G/4G/5G) wireless wide area network (WWAN) radio in a first time interval and then transmit via a WiFi radio in a second time interval, where both the time intervals are within the time-averaging window specified by the regulator or standard.

The RF exposure map may be representative of RF exposure contributions from a plurality of antennas of the wireless device. For example, the RF exposure map may include the maximum RF exposure values associated with a plurality of composite exposure maps (e.g., the composite maps 1202a-h) in a subset of regions (e.g., the regions 1102). The RF exposure map may be representative of the RF exposure contributions arranged in at least two dimensions (e.g., x-axis and y-axis coordinate system or x-axis, y-axis, and z-axis coordinate system). The RF exposure map may be representative of the RF exposure contributions across one or more surfaces of the wireless device. In certain aspects, the RF exposure map may be represented as a look-up table of maximum RF exposures associated with multiple regions per antenna among a plurality of antennas of the wireless device, for example, as depicted in FIG. 13. In certain aspects, the RF exposure map may be representative of RF exposure contributions from at least one antenna of the wireless device relative to one or more RF exposure scenarios (e.g., head exposure, hand or extremity exposure, body or torso exposure, and/or a hotspot exposure scenario). The representation of the maximum RF exposure for the region may allow determination of the transmit power of the at least one antenna to ensure compliance with the RF exposure limit.

In certain aspects, the RF exposure contributions from the antennas are across a range of frequencies. The range of frequencies may include sub-6 GHz bands, mmWave bands, or a combination thereof. The RF exposure contributions may be derived from multiple bands, such as sub-6 GHz bands and mmWave bands. The RF exposure contributions include first RF exposure contributions from sub-6 GHz bands and second RF exposure contributions from mmWave bands.

The region corresponding to the maximum RF exposure in the RF exposure map may include an area of multiple points in the RF exposure map. The region may be a sub-region (or sub-area) of a larger exposure region associated with the at least one antenna. The region may be a collection of one or more points belonging to a larger exposure region associated with the at least one antenna. For example, in some cases, the region may be a single point or a collection of sparse points (that may not comprise an area or contiguous points). The RF exposure map includes the representation of the maximum RF exposure for each of a plurality of regions (e.g., the region 1102) including the region.

In certain aspects, the wireless device may determine the transmit power using backoff information (e.g., one or more backoff factors) applied to the RF exposure map. For example, the wireless device may adjust the RF exposure map by the backoff factor to determine RF exposure compliance.

For certain aspects, the wireless device may use multiple RF exposure maps to determine RF exposure compliance, where each of the RF exposure maps is associated with a different exposure or transmission scenario for the wireless device. For example, to access the RF exposure map, the wireless device may access the RF exposure map among a plurality of RF exposure maps, where each of the RF exposure maps is representative of a different exposure or transmission scenario (e.g., antenna ON/OFF combinations across the wireless device) or a different sets of exposure scenarios for the wireless device. The different exposure or transmission scenarios may include various combinations of radios, beams, bands, antennas, and/or antenna groups being active or inactive. For example, each of the RF exposure maps may be associated with a different combination of one or more active antennas among a plurality of antennas of the wireless device. In some cases, the different exposure or transmission scenarios may correspond to different positions relative to and/or proximity to a human body (e.g., head exposure, hand or extremity exposure, body or torso exposure, and/or a hotspot exposure scenario). A set of exposure scenarios may correspond to a combination of any of head exposure, hand or extremity exposure, body or torso exposure, and/or a hotspot exposure scenario.

In certain aspects, the wireless device may determine transmit power for a future time interval in a time window associated with a time-averaged RF exposure limit. For example, the wireless device may obtain a total transmit power of past time intervals within a time window associated with the RF exposure limit. The wireless device may have transmitted in different exposure or transmission scenario(s) in any of the past time intervals within a time window associated with the RF exposure limit. The wireless device may determine a provisional transmit power for a future time interval within the time window. The wireless device may convert a sum of the provisional transmit power and the total transmit power to a time-averaged RF exposure value for the time window based on the RF exposure map. The wireless device may adjust the provisional transmit power such that the time-averaged RF exposure value satisfies the RF exposure limit. The wireless device may transmit the signal at the transmit power being less than or equal to the adjusted provisional transmit power that satisfies the RF exposure limit. For certain aspects, the RF exposure limit may include a time-averaged SAR limit, a time-averaged PD limit, or any combination thereof.

While the examples depicted in FIGS. 1-18 are described herein with respect to a UE performing the various methods for providing RF exposure compliance to facilitate understanding, aspects of the present disclosure may also be applied to other wireless devices, such as a wireless station, an access point, a base station and/or a customer premises equipment (CPE), performing the RF exposure compliance described herein. Further, while the examples are described with respect to communications between the UE (or other wireless device) and a network entity, the UE or other wireless device may be communicating with a device other than a network entity, for example another UE or with another device in a user's home that is not a network entity, for example.

It will be appreciated that the compressed RF exposure map described herein may enable desirable wireless communication performance, such as reduced latencies, increased uplink data rates, and/or an uplink connection at the edge of a cell. The compressed RF exposure map described herein may provide efficient RF exposure compliance with region-specific RF exposure values relative to an RF exposure map.

### Example Communications Device

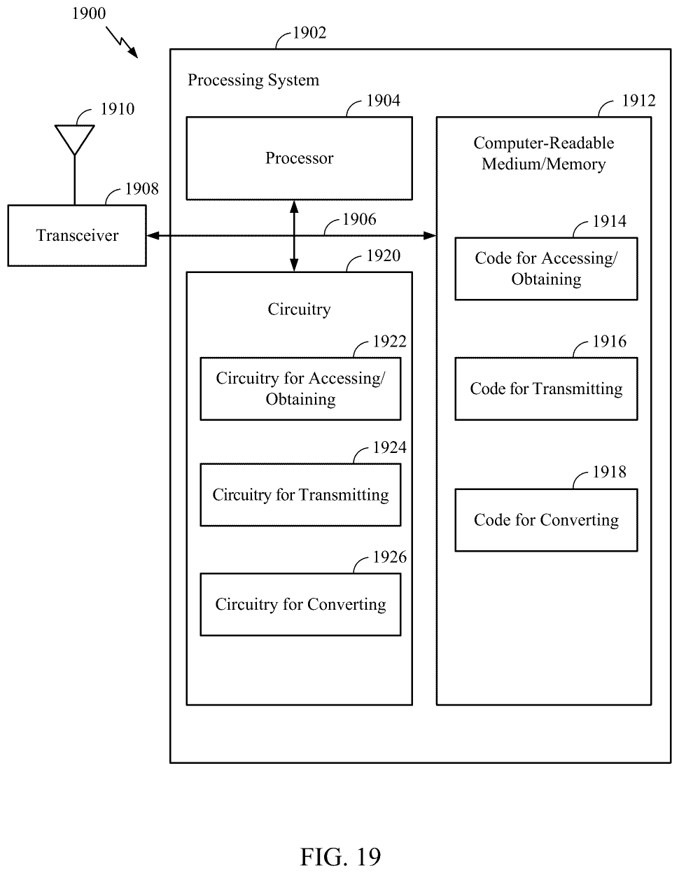

FIG. 19 illustrates a communications device 1900 (e.g., the UE 120) that may include various components (e.g., corresponding to means-plus-function components) configured to perform operations for the techniques disclosed herein, such as the operations illustrated in FIG. 17, the operations illustrated in FIG. 18, or other operations described herein for providing RF exposure compliance. The communications device 1900 includes a processing system 1902, which may be coupled to a transceiver 1908 (e.g., a transmitter and/or a receiver). The transceiver 1908 is configured to transmit and receive signals for the communications device 1900 via an antenna 1910, such as the various signals as described herein. The processing system 1902 may be configured to perform processing functions for the communications device 1900, including processing signals received and/or to be transmitted by the communications device 1900.

The processing system 1902 includes a processor 1904 coupled to a computer-readable medium/memory 1912 via a bus 1906. In certain aspects, the computer-readable medium/memory 1912 is configured to store instructions (e.g., computer-executable code) that when executed by the processor 1904, cause the communications device 1900 to perform the operations 1700 illustrated in FIG. 17, the operations 1800 illustrated in FIG. 18, or other operations for performing the various techniques discussed herein for providing RF exposure compliance. In certain aspects, computer-readable medium/memory 1912 stores code for accessing (or obtaining) 1914, code for transmitting (or outputting) 1916, code for converting 1918, or any combination thereof.

In certain aspects, the processing system 1902 has circuitry 1920 configured to implement the code stored in the computer-readable medium/memory 1912. In certain aspects, the circuitry 1920 is coupled to the processor 1904 and/or the computer-readable medium/memory 1912 via the bus 1906. For example, the circuitry 1920 includes circuitry for accessing (or obtaining) 1922, circuitry for transmitting (or outputting) 1924, circuitry for converting 1926, or any combination thereof.

In some examples, means for transmitting or sending (or means for outputting for transmission) may include the transceivers 254 and/or antenna(s) 252 of the UE 120 illustrated in FIG. 2 and/or transceiver 1908 and antenna 1910 of the communications device 1900 in FIG. 19.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for accessing and/or means for converting may include various processing system components, such as: the processor 1904 in FIG. 19, or aspects of the UE 120 depicted in FIG. 2, including receive processor 258, transmit processor 264, TX MIMO processor 266, and/or controller/processor 280.

### Example Aspects

Implementation examples are described in the following numbered clauses:

Aspect 1: A method of wireless communication by a wireless device, comprising: accessing a radio frequency (RF) exposure map associated with at least one antenna of the wireless device, wherein the RF exposure map includes a representation of a maximum RF exposure for a region of the RF exposure map; and transmitting, from the at least one antenna, a signal at a transmit power determined based at least in part on the RF exposure map in compliance with an RF exposure limit.

Aspect 2: The method of Aspect 1, wherein the RF exposure map is representative of RF exposure contributions from a plurality of antennas of the wireless device.

Aspect 3: The method of Aspect 2, wherein the RF exposure map is representative of the RF exposure contributions arranged in at least two dimensions.

Aspect 4: The method of Aspect 2 or 3, wherein the RF exposure contributions are across a range of frequencies.

Aspect 5: The method of Aspect 4, wherein the range of frequencies comprises sub-6 GHz bands, mmWave bands, or a combination thereof.

Aspect 6: The method of Aspect 4 or 5, wherein the RF exposure contributions include first RF exposure contributions from sub-6 GHz bands and second RF exposure contributions from mmWave bands.

Aspect 7: The method according to any of Aspects 1-6, wherein the RF exposure map is representative of RF exposure contributions across a plurality of surfaces of the wireless device.

Aspect 8: The method according to any of Aspects 1-7, wherein the RF exposure map is representative of RF exposure contributions from at least one antenna of the wireless device relative to one or more RF exposure scenarios.

Aspect 9: The method according to any of Aspects 1-8, wherein: the region is a sub-region of a larger exposure region associated with the at least one antenna; the region is representative of one or more points of a larger exposure region associated with the at least one antenna; or the region is representative of one or more values of RF exposure contributions associated with the at least one antenna.

Aspect 10: The method according to any of Aspects 1-9, wherein the representation of the maximum RF exposure for the region allows determination of the transmit power of the at least one antenna to ensure compliance with the RF exposure limit.

Aspect 11: The method according to any of Aspects 1-10, wherein the RF exposure map includes the representation of the maximum RF exposure for each of a plurality of regions including the region.

Aspect 12: The method according to any of Aspects 1-11, further comprising determining the transmit power using backoff information applied to the RF exposure map.

Aspect 13: The method according to any of Aspects 1-12, wherein accessing the RF exposure map comprises accessing the RF exposure map among a plurality of RF exposure maps, wherein each of the RF exposure maps is representative of a different exposure scenario or a different set of exposure scenarios for the wireless device.

Aspect 14: The method of Aspect 13, wherein each of the RF exposure maps has a different combination of one or more active antennas among a plurality of antennas of the wireless device.

Aspect 15: The method according to any of Aspects 1-15, further comprising: obtaining a total transmit power of past time intervals within a time window associated with the RF exposure limit; determining a provisional transmit power for a future time interval within the time window; converting a sum of the provisional transmit power and the total transmit power to a time-averaged RF exposure value for the time window based on the RF exposure map; and adjusting the provisional transmit power such that the time-averaged RF exposure value satisfies the RF exposure limit, wherein transmitting the signal comprises transmitting the signal at the transmit power being less than or equal to the adjusted provisional transmit power that satisfies the RF exposure limit.

Aspect 16: The method according to any of Aspects 1-15, wherein the RF exposure limit includes a time-averaged specific absorption rate (SAR) limit, a time-averaged power density (PD) limit, or any combination thereof.

Aspect 17: A method of generating a radio frequency (RF) exposure map, comprising: obtaining a first RF exposure map associated with at least one antenna of a wireless device; and converting the first RF exposure map to a second RF exposure map, wherein the second RF exposure map is compressed compared to the first RF exposure map.

Aspect 18: The method of Aspect 17, wherein converting the first RF exposure map comprises generating a look-up table of exposure contributions across different regions using the first RF exposure map.

Aspect 19: The method of Aspect 17 or 18, further comprising: accessing the second RF exposure map associated with the at least one antenna of the wireless device, wherein the second RF exposure map includes a representation of a maximum RF exposure for a region; and transmitting, from the at least one antenna, a signal at a transmit power determined based at least in part on the second RF exposure map in compliance with an RF exposure limit.

Aspect 20: The method of Aspect 19, wherein the representation of the maximum RF exposure for the region allows determination of the transmit power of the at least one antenna to ensure compliance with the RF exposure limit.

Aspect 21: The method according to any of Aspects 17-20, wherein obtaining the first RF exposure map comprises: obtaining a plurality of RF exposure maps, wherein each of the RF exposure maps is representative of an RF distribution for a different antenna; and combining the plurality of RF exposure maps to form the first RF exposure map.

Aspect 22: The method according to any of Aspects 17-21, wherein the first RF exposure map includes normalized RF exposure contributions from a plurality of antennas of the wireless device.

Aspect 23: The method according to any of Aspects 17-22, wherein the first RF exposure map is indicative of RF exposure contributions from a plurality of antennas of the wireless device across one or more surfaces of the wireless device.

Aspect 24: The method of Aspect 23, wherein the first RF exposure map includes a representation of the RF exposure contributions arranged in at least two dimensions.

Aspect 25: The method according to any of Aspects 17-24, wherein converting the first RF exposure map to the second RF exposure map comprises: segmenting the first RF exposure map into a plurality of regions; selecting, for each of the regions, a maximum RF exposure value among a plurality of values in the respective region; and generating the second RF exposure map as the selected maximum RF exposure values in the regions.

Aspect 26: The method of Aspect 25, wherein converting the first RF exposure map to the second RF exposure map further comprises: determining a total normalized composite RF exposure map for a plurality of antennas based on a backoff factor and the first RF exposure map at a reduced resolution; and re-segmenting the first RF exposure map into the plurality of regions until the backoff factor satisfies a threshold for computing the total normalized composite RF exposure map at a full resolution of the first RF exposure map.

Aspect 27: The method according to any of Aspects 17-26, wherein: obtaining the first RF exposure map comprises combining a plurality of RF exposure maps to form the first RF exposure map; and converting the first RF exposure map to the second RF exposure map comprises: segmenting the first RF exposure map into a plurality of regions, selecting, for each of the regions, a maximum RF exposure value among a plurality of values in the respective region, determining a total normalized composite RF exposure map for a plurality of antennas based on a backoff factor and the selected maximum RF exposure values in the regions, and re-segmenting the first RF exposure map into the plurality of regions until the backoff factor satisfies a threshold for computing the total normalized composite RF exposure map at a full resolution of the first RF exposure map.

Aspect 28: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-27.

Aspect 29: An apparatus, comprising means for performing a method in accordance with any of Aspects 1-27.

Aspect 30: A non-transitory computer-readable medium comprising computer-executable instructions that, when executed by one or more processors of a processing system, cause the processing system to perform a method in accordance with any of Aspects 1-27.

Aspect 31: A computer program product embodied on a computer-readable storage medium comprising code for performing a method in accordance with any of Aspects 1-27.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a closed subscriber group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a customer premises equipment (CPE), a cellular phone, a smart phone, a personal digital assistant (PDA), a wireless modem, a wireless device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (CMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, which may be narrowband IoT (NB-IOT) devices.

In some examples, access to the air interface may be scheduled. A scheduling entity (e.g., a BS) allocates resources for communication among some or all devices and equipment within the entity's service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, generating, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6, FIG. 14, FIG. 17, and/or FIG. 18.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
accessing a radio frequency (RF) exposure map associated with at least one antenna of the wireless device, wherein the RF exposure map includes a representation of a maximum RF exposure for a region of the RF exposure map; and
transmitting, from the at least one antenna, a signal at a transmit power determined based at least in part on the RF exposure map in compliance with an RF exposure limit.

2. The method of claim 1, wherein the RF exposure map is representative of RF exposure contributions from a plurality of antennas of the wireless device.

3. The method of claim 2, wherein the RF exposure map is representative of the RF exposure contributions arranged in at least two dimensions.

4. The method of claim 2, wherein the RF exposure contributions are across a range of frequencies.

5. The method of claim 4, wherein the range of frequencies comprises sub-6 gigahertz (GHz) bands, millimeter wave (mmWave) bands, or a combination thereof.

6. The method of claim 4, wherein the RF exposure contributions include first RF exposure contributions from sub-6 gigahertz (GHz) bands and second RF exposure contributions from millimeter wave (mmWave) bands.

7. The method of claim 1, wherein the RF exposure map is representative of RF exposure contributions across a plurality of surfaces of the wireless device.

8. The method of claim 1, wherein the RF exposure map is representative of RF exposure contributions from at least one antenna of the wireless device relative to one or more RF exposure scenarios.

9. The method of claim 1, wherein the region is representative of (i) one or more points of a larger exposure region associated with the at least one antenna or (ii) one or more values of RF exposure contributions associated with the at least one antenna.

10. The method of claim 1, wherein the representation of the maximum RF exposure for the region allows determination of the transmit power of the at least one antenna to ensure compliance with the RF exposure limit.

11. The method of claim 1, wherein the RF exposure map includes the representation of the maximum RF exposure for each of a plurality of regions including the region.

12. The method of claim 1, further comprising determining the transmit power using backoff information applied to the RF exposure map.

13. The method of claim 1, wherein accessing the RF exposure map comprises accessing the RF exposure map among a plurality of RF exposure maps, wherein each of the RF exposure maps is representative of a different exposure scenario or a different set of exposure scenarios for the wireless device.

14. The method of claim 13, wherein each of the RF exposure maps has a different combination of one or more active antennas among a plurality of antennas of the wireless device.

15. The method of claim 1, further comprising:
obtaining a total transmit power of past time intervals within a time window associated with the RF exposure limit;
determining a provisional transmit power for a future time interval within the time window;
converting a sum of the provisional transmit power and the total transmit power to a time-averaged RF exposure value for the time window based on the RF exposure map; and
adjusting the provisional transmit power such that the time-averaged RF exposure value satisfies the RF exposure limit, wherein transmitting the signal comprises transmitting the signal at the transmit power being less than or equal to the adjusted provisional transmit power that satisfies the RF exposure limit.

16. The method of claim 1, wherein the RF exposure limit includes a time-averaged specific absorption rate (SAR) limit, a time-averaged power density (PD) limit, or any combination thereof.

17. A method of generating a radio frequency (RF) exposure map, comprising:
obtaining a first RF exposure map associated with at least one antenna of a wireless device; and
converting the first RF exposure map to a second RF exposure map, wherein the second RF exposure map is compressed compared to the first RF exposure map.

18. The method of claim 17, wherein converting the first RF exposure map comprises generating a look-up table of exposure contributions across different regions using the first RF exposure map.

19. The method of claim 17, further comprising:
accessing the second RF exposure map associated with the at least one antenna of the wireless device, wherein the second RF exposure map includes a representation of a maximum RF exposure for a region; and
transmitting, from the at least one antenna, a signal at a transmit power determined based at least in part on the second RF exposure map in compliance with an RF exposure limit.

20. The method of claim 19, wherein the representation of the maximum RF exposure for the region allows determination of the transmit power of the at least one antenna to ensure compliance with the RF exposure limit.

21. The method of claim 17, wherein obtaining the first RF exposure map comprises:
obtaining a plurality of RF exposure maps, wherein each of the RF exposure maps is representative of an RF distribution for a different antenna; and
combining the plurality of RF exposure maps to form the first RF exposure map.

22. The method of claim 17, wherein the first RF exposure map includes normalized RF exposure contributions from a plurality of antennas of the wireless device.

23. The method of claim 17, wherein the first RF exposure map is indicative of RF exposure contributions from a plurality of antennas of the wireless device across one or more surfaces of the wireless device.

24. The method of claim 23, wherein the first RF exposure map includes a representation of the RF exposure contributions arranged in at least two dimensions.

25. The method of claim 17, wherein converting the first RF exposure map to the second RF exposure map comprises:
segmenting the first RF exposure map into a plurality of regions;
selecting, for each of the regions, a maximum RF exposure value among a plurality of values in the respective region; and
generating the second RF exposure map as the selected maximum RF exposure values in the regions.

26. The method of claim 25, wherein converting the first RF exposure map to the second RF exposure map further comprises:
determining a total normalized composite RF exposure map for a plurality of antennas based on a backoff factor and the first RF exposure map at a reduced resolution; and
re-segmenting the first RF exposure map into the plurality of regions until the backoff factor satisfies a threshold for computing the total normalized composite RF exposure map at a full resolution of the first RF exposure map.

27. The method of claim 17, wherein:
obtaining the first RF exposure map comprises combining a plurality of RF exposure maps to form the first RF exposure map; and
converting the first RF exposure map to the second RF exposure map comprises:
segmenting the first RF exposure map into a plurality of regions,
selecting, for each of the regions, a maximum RF exposure value among a plurality of values in the respective region,
determining a total normalized composite RF exposure map for a plurality of antennas based on a backoff factor and the selected maximum RF exposure values in the regions, and
re-segmenting the first RF exposure map into the plurality of regions until the backoff factor satisfies a threshold for computing the total normalized composite RF exposure map at a full resolution of the first RF exposure map.

28. An apparatus for wireless communication, comprising:
one or more memories collectively storing executable instructions; and
one or more processors coupled to the one or more memories, the one or more processors being collectively configured to execute the executable instructions to cause the apparatus to:
access a radio frequency (RF) exposure map associated with at least one antenna of the apparatus, wherein the RF exposure map includes a representation of a maximum RF exposure for a region of the RF exposure map; and
control transmission of, from the at least one antenna, a signal at a transmit power determined based at least in part on the RF exposure map in compliance with an RF exposure limit.

29. An apparatus for generating a radio frequency (RF) exposure map, comprising:
one or more memories collectively storing executable instructions; and
one or more processors coupled to the one or more memories, the one or more processors being collectively configured to execute the executable instructions to cause the apparatus to:
obtain a first RF exposure map associated with at least one antenna of a wireless device; and
convert the first RF exposure map to a second RF exposure map, wherein the second RF exposure map is compressed compared to the first RF exposure map.

30. The apparatus of claim 29, wherein the one or more processors are further collectively configured to execute the executable instructions to cause the apparatus to:
access the second RF exposure map associated with the at least one antenna of the wireless device, wherein the second RF exposure map includes a representation of a maximum RF exposure for a region; and
transmit, from the at least one antenna, a signal at a transmit power determined based at least in part on the second RF exposure map in compliance with an RF exposure limit.
